(19) United States
(12) Patent Application Publication
(10) Pub. No.: US 2016/0036786 A1
(43) Pub. Date: Feb. 4, 2016

(54) SYSTEM AND METHOD FACILITATING ENHANCED INTER-OBJECT AND HUMAN-OBJECT INTERACTIVITY USING NETWORKED ELECTRONIC DEVICES

(71) Applicant: HARDIK PRAKASH GANDHI, SUNNYVALE, CA (US)

(72) Inventor: HARDIK PRAKASH GANDHI, SUNNYVALE, CA (US)

(21) Appl. No.: 14/816,067

(22) Filed: Aug. 3, 2015

Related U.S. Application Data
(60) Provisional application No. 62/032,530, filed on Aug. 2, 2014.

(51) Int. Cl. H04L 29/06; H04L 29/08

(52) U.S. Cl. CPC H04L 63/0428; H04L 67/32

(57) ABSTRACT

Embodiments of the present invention disclose a method for facilitating enhanced inter-object and human-object interactivity using networked electronic devices. The method comprises providing one or more passive and active objects, generating and assigning a unique, encrypted and network-based Identification (ID) code corresponding to each of the one or more passive and active objects, custom designing a physical object Identification (ID) tag corresponding to each of the one or more passive and active objects, coupling the generated unique, encrypted and network-based Identification (ID) code with the physical object Identification (ID) tag corresponding to each of the one or more passive and active objects, retrofitting the physical object Identification (ID) tag to each of the one or more passive and active objects, providing a network for facilitating inter-object interactions and human interactions therewith, and interacting with the one or more passive and active objects retrofitted with the custom designed physical object Identification (ID) tags using one or more of at least one of portable and wearable computing and communications devices via the network, thereby facilitating realization of web of everything and anything.

### CROSS-REFERENCE TO RELATED APPLICATIONS

This application claims benefit of the U.S. Provisional Patent Application No. 62/032,530 filed Aug. 2, 2014, which is incorporated herein by reference in its entirety.

### BACKGROUND OF THE INVENTION

1. Field of the Invention

Embodiments of the present invention generally relate to Internet or Web of Everything and Anything (IOEA or WOEA), and more particularly, to connecting everything and anything to Anyone, Anytime, Anywhere, Anyway (5 A's) with enhanced inter-object and human-object interactivity using networked electronic devices and at least one of tamper-evident, tamper-proof, tamper-resistant patterned, and a combination thereof, multi-layered, custom-designed, retro-coupled (or retro-fitted) physical object Identification (ID) tags (or labels) coupled to objects comprising object Identification (ID) codes, with one or more qualitative parameters of merit, such as user-friendly, economical, at least one of openly and securely accessible, non-reproducible, non-reusable, unique, encrypted, at least one of offline and online network-dependent.

2. Description of the Related Art

In general, human interactions with one or more objects in the ambiances or surroundings is based on one or more human senses, namely sight or vision, hearing or audition, taste or gestation, smell or olfaction, touch or somatosensation. Specifically, the sensory ecology, perception and interactions allow humans to gain useful information in connection with objects or things, such as color, texture or geometry, size or dimensions, weight, material or matter, odor, and the like. However, many manufactured objects, for instance packaged food items, mechanical and electrical goods, still have labels or tags stuck, printed, embedded, embossed or engraved thereupon so as to provide additional information in connection with the object that is not discernible via human senses or analytical thinking. For example, product labels, Structured Product Labels (SPLs), packaging insets, Country of Origin Labels (COOLs), European Union (EU) energy labels, nutritional facts labels, warning labels and mandatory labels. Specifically, nutritional facts labels provide nutritional content or list of ingredients on consumer products and packaged foods. Likewise, textile labels comprise the size, the pesticide registration number, statement of ingredients, storage and disposal information, method of washing, and the like.

However, problems with all the aforementioned labels are they lack additional desirable information in connection with the objects or things that is not easily available to or accessible by end consumers. For instance, the additional desirable information may comprise data or information in connection with the time (or when), location (or where) and method (or process or how) of manufacturing of the item or object, the time (or when), location (or where) and method (or process or how) of packaging thereof, the time (or when), location (or where) and method (or process or how) of storage and shipping or transit thereof, any and all manufacturing defects, issues and flaws therein, feedback, reviews, comments or opinions therefor from peer users or consumers of relevant competing items, objects or products, pricing, buying, purchasing and selling trends thereof, and the like. As a consequence, all of the aforementioned information is only available to and accessible by the manufacturer, seller or distributor of the products, and not to end consumers at the Point of Sale (POS). One or more solutions to the aforementioned problems is deployment of detection and tracking systems and methods, such as Radio Frequency Identification (RFID) and Near Field Communication (NFC) tags, and the like, to identify or detect and track objects or things, and access and retrieve information in connection with the objects or things via usage of specialized electronic readers and networked or shared databases. However, the aforementioned solutions are only deployed by the manufacturer, seller or distributor of the products. Thus, end consumers shall neither have the aforementioned information at the POS, nor later.

Another major problem is duplication or imitation of Identifier (or Identification or ID) tags, and Identification codes at least one of written, printed, embedded, embossed and engraved thereupon, in illegally produced copies of products, or counterfeit products, thereby rendering ascertaining the genuity or authenticity of the product a difficult task for end consumers. One partial solution to the aforementioned problem is accessing consumer reviews on the products from the Internet subsequent to providing specific details on the products comprising item numbers, manufacturer codes, and the like. However, the foregoing partial solution is onerous, ambiguous, unreliable and time-consuming.

In certain circumstances involving authentication of consumer goods and products, widespread and incessantly, rising availability of counterfeit consumer goods, counterfeit medicinal products or counterfeit medications, such as medicines, bolted water, luxury goods, for instance sun glasses or watches, leads to adverse financial, efficiency, performance, and health impacts on the consumers thereof, thereby posing a major problem. Adding to the foregoing problem are advances in packaging and printing technology, thereby rendering easy replication or imitation in packaging and labeling counterfeit products. As a consequence, differentiating counterfeit consumer goods, counterfeit medicinal products or counterfeit medications from genuine or authentic goods becomes difficult task for end consumers. Some solutions suggest or recommend usage of special product seals or holograms. However, with recent advances in counterfeiting technologies renders the use of the special product seals or holograms as a preventive anti-counterfeiting technique proves to be an ineffective deterrent.

In certain situations involving medical triage and emergency patient management, in the event that emergency patients arrive in the hospitals in the wake of the occurrence of accidents or other unwanted, unexpected and untoward incidents a lot of information in connection with the emergency patients is demanded by the emergency department, such as emergency nurses and operating staff. However, the emergency patients, and family attendants therefor, fail to provide the information in connection with the emergency patients reliably, accurately, completely and in a timely manner. The failure in providing the information in connection with the emergency patients is owing to the fact that the emergency patients, and family attendants therefor, are at least one of under panic, in a state of urgency and not in the right state (or frame) of mind, or the required or demanded information is not readily available. For example, the information in connection with the emergency patients comprises the first, middle and last name, Date of Birth (DOB), primary care physician name, address, city, country, state/province, postal or zip code, unique medical record number, emergency contacts, telephone number, gender, advance directives, marital status, Social Security Number (SSN), unique driving license number, blood type, organ donor, language or mother tongue, faith or religion and unique corporate medical identification number; healthcare information updation date, for instance date last modified or updated; multiple allergy information, for instance allergy type, name of allergen, reaction, source (personal or discharge summary or clinical note) and severity; multiple medications information, for instance generic name and brand name; patient identity verification information, for instance Personal Identification Number(s) (PINs), patient photo or biometric information, identity management information; multiple medical problems information, for instance diagnosis or problem description, expression of problem; multiple surgeries and procedures information, for instance description, date, re-route pipeline to additional data; first responder, Federal Emergency Management Agency (FEMA)/Fracturing Responsibility and Awareness of Chemicals (FRAC) access information, for instance smart healthcare card reading authority, date stamp, audit trail and time limit; insurance or guarantor information, for instance multiple insurance dates, carrier, plan, policy, subscriber name, guarantor data, first, middle and last name, relationship to subscriber and address details; customized additional patient information, for instance implanted devices, pacemakers, artificial valves and defibrillators; customized payment information, for instance AMEX®/VISA®/MASTERCARD® credit/debit card, Health Savings Account/Health Spending Account (HSA) and social healthcare/insurance program. Some solutions to the foregoing problem suggest or recommend usage of Electronic Medical or Health Records (EMRs or EHRs) and smart health cards. However, in unknown, unexpected, unwanted and untimely situations the emergency patients, and family attendants therefor, generally tend to unintentionally forget to carry the smart health cards or fail to recapitulate one or more unique keys required to access and retrieve the information stored in the EMRs or EHRs. In some worst case scenarios involving occurrence of unknown, unexpected, unwanted and untimely situations of emergency in at least one of unknown, unidentified and unreachable regions or locations or areas, the emergency patients may be unfamiliar of, or to, the unknown, unidentified and unreachable regions or locations or areas, or may not be accompanied by the family or known attendants therefor, thereby rendering availability of reliable, accurate and complete demanded or required information in a timely manner a complicated or impossible task.

In some applications involving people detection and tracking, there is often a need for targeting users to detect and track the locations or whereabouts of targeted users, such as peers, family members, for instance spouse, children, teenage girls and elderly, friends, colleagues, social media contacts, and the like. Alternately, in some scenarios, the targeted users, such as peers, family members, for instance spouse, children, teenage girls and elderly, friends, colleagues, social media contacts, and the like may need to update the locations or whereabouts to the targeting users. For example, in some scenarios involving travelling at least one of timely and untimely on at least one of land, air and water from and to at least one of unknown, remote, close and unsafe source and destination locations, respectively, the targeted users, such as peers, family members, for instance spouse, children, teenage girls and elderly, friends, colleagues, social media contacts, and the like may need to periodically send messages to update the locations or whereabouts to the targeting users. One simple and crude solution to the aforementioned problem is sending or transmission of at least one text, voice, visual, video messages, and a combination thereof, for instance multimedia messages from and to commonly available portable computing and communications devices, such as mobile or cell phones. However, the aforementioned solution is neither reliable, not practical in the event that the targeted users are required to update multiple targeting users at least one of selectively, randomly and in a customized-fashion with different message content, different profiles, at different locations in different time zones and in different ways.

In some situations involving Authentication, Authorization and Accounting (AAA) of personnel in at least one of public spaces and private places, Identification (ID) cards with personal photographs and other personal information embedded with at least one of Radio Frequency Identification (RFID), Near Field Communication (NFC), barcodes, Quick Response (QR) codes, digital watermarking, special markings visible under Ultra Violet (UV) light, for instance UV marker, holograms, and the like, are often used to manage, i.e. monitor access and permissions. In some scenarios, custom-designed reading (or scanning) devices and human sentinels/sentries are often required to scan, authenticate and authorize the ID cards. However, ID cards those that are subject to visual (or manual) authentication and authorization are prone to tampering and easy duplication, for instance affixing a wrong or false photograph to a given ID card.

In some circumstances involving electronically controlled access to doors or gates require users to punch or type in or input access codes on a given keypad. The access codes may be known to controlled set of people. One solution towards improving secure access is to alter or change the access codes. However, re-communicating the altered or updated access codes to the authorized users, as well as learning and remembering the altered or updated access codes often may not be practical.

Thus, there is a need for an improved system and method facilitating enhanced inter-object and human-object interactivity between physical objects or things and humans using networked electronic devices and physical object Identification (ID) tags (or labels) comprising Identification (ID) codes coupled thereto, with one or more qualitative parameters of merit, such as user-friendly, economical, at least one of openly and securely accessible, non-reusable, unique, encrypted, at least one of offline and online network-dependent ID code, at least one of tamper-evident, tamper-proof, tamper-resistant patterned, and a combination thereof, multi-layered custom-designed retro-coupled or retro-fitted ID label therefor.

### SUMMARY OF THE INVENTION

Embodiments of the present invention disclose a method for facilitating enhanced inter-object and human-object interactivity using networked electronic devices. The method comprises providing one or more passive and active objects, generating and assigning a unique, encrypted and network-based Identification (ID) code corresponding to each of the one or more passive and active objects, custom designing a physical object Identification (ID) tag corresponding to each of the one or more passive and active objects, coupling the generated unique, encrypted and network-based Identification (ID) code with the physical object Identification (ID) tag corresponding to each of the one or more passive and active objects, retrofitting the physical object Identification (ID) tag to each of the one or more passive and active objects, providing a network for facilitating inter-object interactions and human interactions therewith, and interacting with the one or more passive and active objects retrofitted with the custom designed physical object Identification (ID) tags using one or more of at least one of portable and wearable computing and communications devices via the network, thereby facilitating realization of web of everything and anything. The step of interacting with the one or more passive and active objects retrofitted with the custom designed physical object Identification (ID) tags using one or more of at least one of portable and wearable computing and communications devices via the network further comprises at least one of downloading, installing and implementing a proprietary object Identity (ID) management application using the at least one of portable and wearable computing and communications device, inputting the login credentials of a registered user comprising a User Identifier (UID) and a corresponding Password (PWD) for Authentication, Authorization and Accounting (AAA) of the registered user by at least one of an offline networked and online cloud-based secure host computing unit, thereby facilitating initiation of the proprietary object Identity (ID) management application, upon successful AAA of the registered user, at least one of scanning and optionally inputting the unique, encrypted and network-based Identification (ID) code generated and assigned to each of the one or more passive and active objects using an object Identification (ID) code scanner of the object Identity (ID) management application, decrypting the unique, encrypted and network-based Identification (ID) code generated and assigned to each of the one or more passive and active objects using an object Identification (ID) code encrypter/decrypter of the object Identity (ID) management application, accessing the at least one of an offline networked and online cloud-based secure host computing unit using the decrypted Identification (ID) code corresponding to each of the one or more passive and active objects to retrieve the information in connection therewith, determining the access type and activation state of the Identification (ID) code corresponding to each of the one or more passive and active objects, wherein the access type is at least one of open and limited, whereas the activation state is at least one of activated and deactivated, activating the Identification (ID) code corresponding to each of the one or more passive and active objects to define one or more access permissions to the Identification (ID) code for at least one of individual and group users and the time period of expiry of the Identification (ID) code as an owner user, analyzing the information in connection with the each of the one or more passive and active objects, profiling each of the one or more passive and active objects partly based on at last one of the results of the analysis, the historical use, context of use, corresponding users, attributes, functions and performance thereof, categorizing each of the one or more passive and active objects based on the profile, recommending one or more uses of the each of the one or more passive and active objects, and at least one of applicability and reliability thereof, based on at least one of the historical use, context of use, pricing trends, demand patterns, corresponding users, attributes thereof, functions and performance, and tracking efficacy of the each of the one or more passive and active objects based on at least one of performance, sales, efficiency, peer reviews, and the like.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 depicts a block diagrammatic representation of the improved system and method facilitating realization of IOEA or WOEA with enhanced inter-object and human-object interactivity using networked electronic devices, according to one or more embodiments;

FIG. 2 depicts a detailed block diagrammatic representation of the retro-coupled, proprietary and custom-designed smart labels (or tags) for labeling or tagging the passive and active devices or objects, thereby facilitating realizing IOEA or WOEA, for connecting everything and Anything to Anyone, Anytime, Anywhere, Anyway (5 A's) with enhanced inter-object and human-object interactivity, according to one or more embodiments;

FIG. 3 depicts a block diagrammatic representation of the proprietary and custom-designed smart labels (or tags) comprising unique, encrypted and online network-based Identification (ID) codes imprinted thereupon or therein, and serving as a retrofit to physical objects or devices, according to one or more embodiments;

FIGS. 4A-B depict a flow diagram in connection with the method for generating, assigning and implementing the unique, encrypted and online or offline network-based Identification (ID) codes corresponding to the passive and active devices or objects, thereby facilitating enhanced human-object interactivity, according to one or more embodiments; and

FIG. 5 depicts a computer system that may be a computing device and may be utilized in various embodiments of the present invention.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the improved system and method facilitating enhanced inter-object and human-object interactivity using networked electronic devices, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the improved system and method facilitating enhanced inter-object and human-object interactivity using networked electronic devices defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention disclose a method for facilitating enhanced inter-object and human-object interactivity using networked electronic devices. The method comprises providing one or more passive and active objects, generating and assigning a unique, encrypted and network-based Identification (ID) code corresponding to each of the one or more passive and active objects, custom designing a physical object Identification (ID) tag corresponding to each of the one or more passive and active objects, coupling the generated unique, encrypted and network-based Identification (ID) code with the physical object Identification (ID) tag corresponding to each of the one or more passive and active objects, retrofitting the physical object Identification (ID) tag to each of the one or more passive and active objects, providing a network for facilitating inter-object interactions and human interactions therewith, and interacting with the one or more passive and active objects retrofitted with the custom designed physical object Identification (ID) tags using one or more of at least one of portable and wearable computing and communications devices via the network, thereby facilitating realization of web of everything and anything. The step of interacting with the one or more passive and active objects retrofitted with the custom designed physical object Identification (ID) tags using one or more of at least one of portable and wearable computing and communications devices via the network further comprises at least one of downloading, installing and implementing a proprietary object Identity (ID) management application using the at least one of portable and wearable computing and communications device, inputting the login credentials of a registered user comprising a User Identifier (UID) and a corresponding Password (PWD) for Authentication, Authorization and Accounting (AAA) of the registered user by at least one of an offline networked and online cloud-based secure host computing unit, thereby facilitating initiation of the proprietary object Identity (ID) management application, upon successful AAA of the registered user, at least one of scanning and optionally inputting the unique, encrypted and network-based Identification (ID) code generated and assigned to each of the one or more passive and active objects using an object Identification (ID) code scanner of the object Identity (ID) management application, decrypting the unique, encrypted and network-based Identification (ID) code generated and assigned to each of the one or more passive and active objects using an object Identification (ID) code encrypter/decrypter of the object Identity (ID) management application, accessing the at least one of an offline networked and online cloud-based secure host computing unit using the decrypted Identification (ID) code corresponding to each of the one or more passive and active objects to retrieve the information in connection therewith, determining the access type and activation state of the Identification (ID) code corresponding to each of the one or more passive and active objects, wherein the access type is at least one of open and limited, whereas the activation state is at least one of activated and deactivated, activating the Identification (ID) code corresponding to each of the one or more passive and active objects to define one or more access permissions to the Identification (ID) code for at least one of individual and group users and the time period of expiry of the Identification (ID) code as an owner user, analyzing the information in connection with the each of the one or more passive and active objects, profiling each of the one or more passive and active objects partly based on at last one of the results of the analysis, the historical use, context of use, corresponding users, attributes, functions and performance thereof, categorizing each of the one or more passive and active objects based on the profile, recommending one or more uses of the each of the one or more passive and active objects, and at least one of applicability and reliability thereof, based on at least one of the historical use, context of use, pricing trends, demand patterns, corresponding users, attributes thereof, functions and performance, and tracking efficacy of the each of the one or more passive and active objects based on at least one of performance, sales, efficiency, peer reviews, and the like.

In some embodiments, systems and methods facilitating realization of Internet or Web of Everything and Anything (IOEA or WOEA) with enhanced inter-object and human-object interactivity using networked electronic devices are disclosed, in accordance with the principles of the present invention. Specifically, the systems and methods of the present invention facilitate realizing IOEA or WOEA, thereby connecting Everything and Anything to Anyone, Anytime, Anywhere, Anyway (5 A's) with enhanced inter-object and human-object interactivity using networked electronic devices, in accordance with the principles of the present invention. More specifically, the systems and methods of the present invention facilitate managing things or objects, such as object detection, recognition, categorization and tracking, one or more interactions therebetween, i.e. inter-object interactions, and human interactions therewith, such as at least one of “Human-to-Human,” “Object-to-Object,” “Human-to-Object”, and combinations thereof using the networked electronic devices, for instance at least one of portable and wearable computing and communications devices, in accordance with the principles of the present invention. For example, and in no way limiting the scope of the invention, generally the things or objects are at least one of electronic, non-electronic, smart and dummy, and at least one of passive (offline), active (connected or online), respectively.

As used in the current context, the term “things or everything or anything” refers to passive objects, for instance buildings, furniture, bags, food packages, medicines, and the like. The aforementioned passive objects are offline, i.e. lack connection to communication networks, such as the Internet or at least one of other wired and wireless networks. In addition, in the current context, the term “things or everything or anything” intermittently refers to passive apparatuses, devices, and home appliances.

As used in the current context, the term “apparatus” refers to a machine, which is a tool containing one or more parts that uses energy to perform an intended action. Machines are usually powered by mechanical, chemical, thermal, or electrical means, and are often motorized. In addition, the term “apparatus” also refers to equipment.

As used in the current context, the term “device” refers to anything that has a useful purpose. For example, a shoe has a purpose. The purpose of the shoe is to provide comfort and/or protection to the feet of the wearer. Therefore, the shoe is a device. As used in the domain of technology, examples of devices are machines, tools, gadgets, appliances, peripherals, electronic components, and the like.

As used in the current context, the term “home appliance” refers to electrical/mechanical machines, which accomplish some household functions, such as cooking or cleaning. Home appliances can be classified into major appliances (domestic appliance). Major appliances are large machines used for routine housekeeping tasks, such as cooking, washing laundry, food preservation, air conditioners, dishwashers, clothes dryers, drying cabinets, freezers, refrigerators, kitchen stoves, water heaters, washing machines, trash compactors, microwave ovens, induction cookers, and the like. Likewise, small appliances are portable or semi-portable machines, generally used on table-tops, counter-tops, or other platforms, to accomplish household tasks, for instance toasters, humidifiers, coffee makers, home electronics, TV sets, CD and DVD players, camcorders, still cameras, clocks, alarm clocks, video game consoles, High-Fidelity (Hi-Fi) and home cinema, telephones, answering machines, and the like. Still likewise, consumer electronics are electronic equipment intended for everyday use, most often in entertainment, communications and office productivity, such as offline or passive Personal Computers (PCs), telephones, MP3 players, audio equipment, televisions, calculators, digital cameras, players and recorders using video media, such as Digital Versatile Disc (DVD) players, Video Cassette Recorders (VCRs), camcorders, and the like.

In some embodiments, for example, and in no way limiting the scope of the invention, the passive objects or things are at least one of portable, semi-portable and fixed physical properties, such as the aforementioned devices, apparatuses, equipments, machines, appliances, furniture, and the like.

In addition, in the current context, the term “things or everything or anything” intermittently refers to active or online apparatuses, devices, and home appliances.

In some embodiments, from the perspective or by virtue of A) design and operation (function), the objects or things are at least one of electronic and non-electronic, B) connectivity, the objects or things are at least one of passive (offline) and active (online, connected or networked), C) energy consumption and operation, the objects or things are at least one of passive with no requirement of energy source for operation and active requiring energy source for operation, D) deployment/non-deployment of Self-Monitoring, Analysis and Reporting Technology (SMART), the objects or things are at least one of smart (autonomous, intelligent and automated), such as at least one of smart objects, smart connected products, smart devices, smart meters, smart appliances, smart containers, smart portable computing and communications devices, smart wearable computing and communications devices and non-smart (dependent, ordinary, partially manual or automated) objects. For example, and in no way limiting the scope of the invention, the objects or things are at least one of electronic and non-electronic, at least one of passive and active, at least one of smart and non-smart, and combinations thereof.

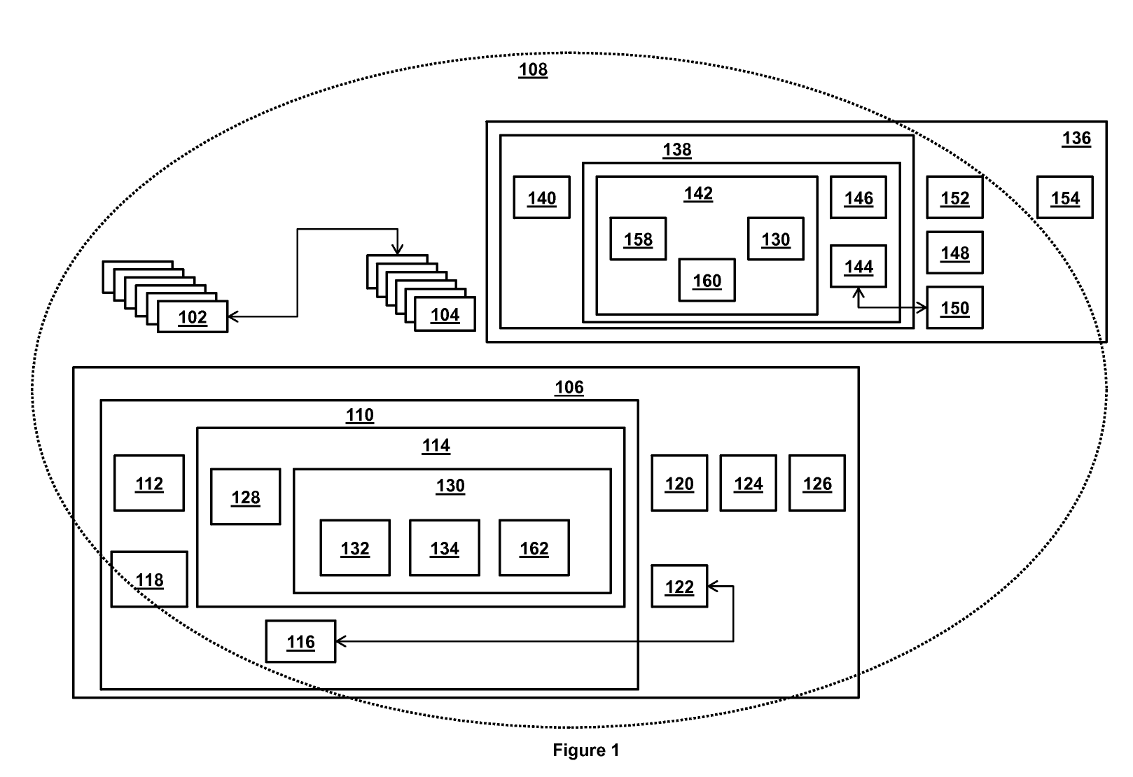

FIG. 1 depicts a block diagrammatic representation of the improved system and method facilitating realization of IOEA or WOEA with enhanced inter-object and human-object interactivity using networked electronic devices, according to one or more embodiments.

The system 100 comprises one or more passive objects (or devices) 102, one or more active objects (or devices) 104, one or more networked electronic devices, for instance one or more of at least one of portable, semi-portable and wearable computing and communications devices 106 and a network subsystem 108.

For example, and in no way limiting the scope of the invention, the passive objects (or devices or things) 102 comprise at least one of offline, i.e. with no connection to the Internet, or other at least one of wired and wireless communications networks, electronic and non-electronic devices, such as bags, food packages, bottles, pets, remote keyless systems with smart keys, calculators, watches, wallets, cameras, sensors, transducers, appliances, and the like.

For example, and in no way limiting the scope of the invention, the active objects (or devices or things) 104 comprise online electronic devices at least one of directly and indirectly, and at least one of wiredly and wirelessly, coupled to the Internet, such as cameras, smart or intelligent cameras, sensors, smart transducers, intelligent sensors, actuators, smart actuators, smart displays, smart meters, smart devices, smart appliances, such as smart or Internet refrigerators, other major and minor home or domestic appliances, smart connected products, smart watch, and the like.

In some embodiments, for example, and in no way limiting the scope of the invention, the online electronic devices are smart or Intelligent Electronic Devices (IEDs). For example, and in no way limiting the scope of the invention, the smart or Intelligent Electronic Devices (IEDs) are smart or Interactive Whiteboards (IWBs), smart toys, smart thermostats, smart shoes, smart retainers, smart locks, smart displays, smart batteries, smart battery chargers, smart boards, smart keys, and the like.

In some embodiments, each of the portable computing and communications devices 106 is at least one of a portable computing device, portable communication device and a combination thereof, for instance a portable computing and communication device. In some embodiments, each of the portable computing devices 106 is at least one of a portable computer, tablet computer, Personal Digital Assistant (PDA), an ultra mobile PC, a smart phone, carputer, portable communications, pentop computer, and the like. Likewise, in some embodiments, each of the portable communications devices 106 is at least one of a mobile device, and the like. In some embodiments, each of the wearable computing and communications device 106 is at least one of a wearable computing device, wearable communications device and a combination thereof, for instance a wearable computing and communications device. For example, and in no way limiting the scope of the invention, the wearable computing devices 106 is at least one of a smart watch, smart band, smart glass, smart shoe, and the like.

In some embodiments, the network subsystem 108 is at least one of wired and wireless network. As a consequence, the one or more active objects (or devices) 104 and one or more of at least one of portable, semi-portable and wearable computing and communications devices 106 are coupled to each other through the network subsystem 108.

Each of the at least one of portable, semi-portable and wearable computing and communications devices 106 comprises a first microcomputer unit 110. The first microcomputer unit 110 comprises a first microprocessor subunit 112, first memory subunit 114, first Input/Output (I/O) subunit 116 and first support circuits 118, respectively. In addition, each of the at least one of portable and wearable computing and communications devices 106 comprises a first wireless communication transceiver subunit 120. Further, in addition, each of the at least one of portable, semi-portable and wearable computing and communications devices 106 may optionally comprise a first display subunit 122. Specifically, the first display subunit 122 may be coupled to the first Input/Output (I/O) subunit 116. For example, and in no way limiting the scope of the invention, the first display subunit 122 may be a touch-sensitive display facilitating capturing or inputting user touch inputs. In some embodiments, each of at least one of portable, semi-portable and wearable computing and communications devices 106 may comprise a first GPS subunit 124 and a first GPRS subunit 126.

As depicted in FIG. 1, in some embodiments, the first memory subunit 114 comprises a first Operating System (OS) 128 and an object Identity (ID) management application 130. Specifically, the object Identity (ID) management application 130 is in essence a proprietary client-side object Identity (ID) management application 130.

For purposes of clarity and expediency, the object Identity (ID) management application may be hereinafter interchangeably referred to as “object Identification (ID) code (or Identifier) management application” and “object Identification (ID) management application”. Further, for purposes of clarity and expediency, the terms “client-side object Identity (ID) management application” and “server-side object Identity (ID) management application” used hereinafter imply the same aforementioned object Identity (ID) management application both in terms of overall functions and attributes thereof.

The object Identity (ID) management application 130 facilitates generation and assignment of one or more physical object Identification (ID) codes with one or more qualitative parameters-of-merit, such as unique, encrypted, active or online, at least one of tamper-evident, tamper-proof, tamper-resistant, and a combination thereof, corresponding to one or more passive and active objects (or devices) 102 and 104. In addition, the object Identity (ID) management application 130 facilitates encryption of one or more unique online (or offline) network-based Identification (ID) codes and decryption of one or more unique, encrypted and online network-based Identification (ID) codes, respectively, generated and assigned to one or more passive and active objects (or devices) 102 and 104.

In some embodiments, the object Identity (ID) management application is adapted to run on one or more client devices, for instance the at least one of portable, semi-portable and wearable computing and communications devices 106. Specifically, the object Identity (ID) management application is adapted to run on at least one of semi-portable computing devices 106 as a web portal and at least one of portable computing and communications devices 106 as an On Device Portal (ODP or a mobile portal). For example, and in no way limiting the scope of the invention, the object Identity (ID) management application 130 is at least one of online and offline network-based, and at least one of mobile application (mobile app) and web application (web app).

In some embodiments, for example, and in no way limiting the scope of the invention, deployment of the object Identity (ID) management application as at least one of a web-based and mobile-based, Software-as-a-Service (SAAS) application is disclosed, in accordance with the principles of the present invention. In some scenarios, the SAAS application client-side facilitates at least one of capturing (or scanning), inputting (or feeding) unique, online network-based Identification (ID) codes for, or assigned to, one or more passive and active objects, encrypting/encoding the at least one of captured and inputted unique, online network-based Identification (ID) codes, decrypting/decoding the unique, encrypted and online network-based Identification (ID) codes, Authentication, Authorization and Accounting (AAA) of users via usage of user login credentials, accessing and retrieving data or information in connection with the one or more coded passive and active objects from the linked backend database hosted or running on the SAAS application server, uploading data or information to and downloading data or information from the SAAS application server-side, thereby facilitating human-object interactivity, analyzing the coded passive and active objects, profiling the coded passive and active objects based on historical use, context of use, corresponding users (owners and/or operators), performance, function or operation and attributes, categorizing the coded passive and active objects based on profile, recommending use and applicability of the coded passive and active objects and tracking efficacy of the coded passive and active objects.

The object Identity (ID) management application 130 comprises an object Identification (ID) code generator 132 and object Identification (ID) code encrypter/decrypter 134. In addition, the object Identity (ID) management application 130 comprises an object Identification (ID) code scanner or receiver 162.

The object Identification (ID) code generator 132 facilitates generating an optical machine-readable representation of data, for instance a barcode, related to each of the passive and active devices or objects 102 and 104. For example, and in no way limiting the scope of the invention, the generated optical machine-readable representation of data, for instance the barcode, is at least one of a One-Dimensional (1-D) (or linear), Two-Dimensional (2-D) (or Matrix) barcode. The generated optical machine-readable representation of data, for instance the barcode, relating to each of the passive and active devices or objects 102 and 104, is hereinafter referred to as a unique online network-based Identification (ID) code.

In some embodiments involving implementation of an encryption scheme, the message data or information, referred to as a plaintext, is encrypted using an encryption algorithm, thereby generating ciphertext that may only be read upon decryption, in accordance with the principles of the present invention. For example, and in no way limiting the scope of the invention, the encryption scheme generally uses a pseudo-random encryption key generated by an algorithm. Hypothetically, the message or ciphertext may be decrypted without possessing the key, but for a well-designed encryption scheme, large computational resources and skill may be required. In some scenarios, an authorized recipient or user may easily decrypt the message or ciphertext with the key provided by the originator to the authorized recipients or users, but not to unauthorized interceptors.

In some scenarios, for example and in no way limiting the scope of the invention, the types of encryption schemes implemented are at least one of A) symmetric-key encryption schemes (or private-key encryption and secure-key encryption), wherein the encryption and decryption keys remains the same, thereby requiring the communicating parties have the same key so as to achieve secure communication, and B) public-key encryption schemes, wherein the encryption key is published for anyone to use and encrypt messages. However, only the receiving party has access to the decryption key that enables messages to be read.

In some embodiments, for example, and in no way limiting the scope of the invention, the generated unique online network-based Identification (ID) codes are encrypted with secure keys only known to the producer or maker using one or more of the secure key encryption schemes. In some embodiments, upon generation and encryption, the unique, encrypted and online network-based Identification (ID) codes are assigned to the corresponding passive and active objects or devices, and at least one of physically coupled thereto via usage of physical object tags (or labels) and logically coupled thereto via usage of virtual object tags (or labels). For purpose of clarity and expediency, the terms “physical object tags (or labels)” and “virtual object tags (or labels)” may be hereinafter intermittently and interchangeably referred to as “physical object Identification (ID) tags (or labels)” and “virtual object Identification (ID) tags (or labels)”, in that order.

The object Identification (ID) code encrypter/decrypter 134 facilitates encrypting the generated unique online network-based Identification (ID) code. Specifically, in operation, the object Identification (ID) code encrypter/decrypter 134 facilitates encrypting/encoding the generated unique online network-based Identification (ID) code in such a way that only authorized users are be able to access, retrieve and read the same. More specifically, in operation, encryption fails to prevent interception autonomously, however denies the message content, for instance the data or information constituting the generated unique, encrypted and online network-based Identification (ID) code, to the interceptor, for instance an unauthorized user.

The object Identification (ID) code scanner or receiver 162 facilitates at least one of capturing (or scanning), and inputting (or feeding) the unique, encrypted and online network-based Identification (ID) codes. Specifically, in operation, the object Identification (ID) code scanner or receiver 162 facilitates at least one of partially manually capturing (or scanning), and partially manually inputting (or feeding) the unique, encrypted and online network-based Identification (ID) codes, using at least one of the portable and wearable computing and communications devices 106. More specifically, in operation, the object Identification (ID) code scanner or receiver 162 facilitates at least one of partially manually capturing (or scanning), and partially manually inputting (or feeding) the unique, encrypted and online network-based Identification (ID) codes, using at least one of the camera, object Identity (ID) management application 130, and a combination thereof, of the at least one of the portable and wearable computing and communications devices 106.

As depicted in FIG. 1, in some embodiments, the network subsystem 108 comprises at least one of an offline networked and online cloud-based secure host computing unit 136.

In some embodiments, the at least one of offline networked and online cloud-based secure host computing unit 136 comprises a second microcomputer unit 138. The second microcomputer unit 138 comprises a second microprocessor subunit 140, a second memory subunit 142, a second Input/Output (I/O) subunit 144 and second support circuits 146, respectively. In addition, the at least one of offline networked and online cloud-based secure host computing unit 136 comprises a second wireless communication transceiver subunit 148. Further, in addition, the at least one of offline networked and online cloud-based secure host computing unit 136 may optionally comprise a second display subunit 150. Specifically, the second display subunit 150 may be coupled to the second Input/Output (I/O) subunit 144. For example, and in no way limiting the scope of the invention, the second display subunit 150 may be a touch-sensitive display facilitating capturing or inputting user touch inputs. In some embodiments, the at least one of offline networked and online cloud-based secure host computing unit 136 may comprise a second GPS subunit 152 and a second GPRS subunit 154.

In some embodiments, the second memory subunit is capable of facilitating storage and management of information in connection with the passive and active devices (or objects). The second memory subunit is capable of facilitating storage and implementation of proprietary server-side object identity management application software and Database Management System (DBMS) thereby facilitating overall management of the information in the at least one of offline networked and online cloud-based secure host computing unit.

As depicted in FIG. 1, the second memory subunit 142 of the at least one of offline networked and online cloud-based secure host computing unit 136 comprises a second Operating System (OS) 156 and DBMS 158.

In some embodiments, the DBMS is capable of facilitating storage and management of the information in connection with the passive and active devices (or objects) in the form of one or more records. Specifically, each individual record is stored in a database, wherein each individual record comprises one or more attributes or fields. More specifically, the one or more attributes comprises data or information in connection with the passive and active devices (or objects). The DBMS is capable of facilitating at least one of sequential, random and customized searching (or scanning) of the one or more records comprising the data or information in connection with the passive and active devices (or objects), based on one or more criterion, for instance explicit user-definable criteria.

As depicted in FIG. 1, the DBMS 158 comprises a front end application, for instance the proprietary client-side object Identity (ID) management application 130, backend application, for instance the proprietary server-side object Identity (ID) management application 130, and backend database 160. For example, and in no way limiting the scope of the invention, the front end and backend applications 130 may correspondingly serve as the client-side front end and server-side backend for the proprietary object Identity (ID) management application 130.

In some embodiments, the front end application is capable of collecting input in various forms from the user, for instance through a customized Graphical User Interface (GUI) rendered on at least one of portable and wearable computing and communications device owned by the user, and processing the same to conform to a specification both the back end application and database may be capable of consuming. The front end application is capable of serving as an interface between the user and the backend application and database.

In some embodiments, the front end and backend applications are correspondingly distributed amongst one or more clients, for instance in the first memory subunit 114 of the at least one of portable and wearable computing and communications devices 106, and servers, for instance in the second memory subunit 142 of the at least one of offline networked and online cloud-based secure host computing unit 136. For purposes of clarity and expediency, the front end application is hereinafter referred to as client-side front end application. Likewise, the backend application is hereinafter referred to as server-side backend application.

In some embodiments, the backend database is capable of storing any and all information in connection with the passive and active objects or devices received from the at least one of portable and wearable computing and communications device.

In some embodiments involving tagging or labeling the passive and active devices or objects with physical object tags or labels comprising corresponding unique, encrypted and online or offline network-based Identification (ID) codes, generated therefor, as well as assigned thereto, deployment and implementation of proprietary and custom-designed smart tags (or labels) retrofit coupled (or retro-coupled, or as a retrofit, or retrofittable) to the one or more passive and active objects (or devices) is disclosed, in accordance with the principles of the present invention. For example, and in no way limiting the scope of the invention, the retro-coupled, proprietary and custom-designed smart tags (or labels) are in essence at least one of physical and virtual smart object tags (or labels).

As used in general, the term “smart label” refers to a flat responsive device that is usually electronic. Specifically, smart label is a barcode label comprising a transponder. More specifically, smart label, also called smart tag, is an extremely flat configured Radio Frequency Identification (RFID) transponder under a conventional print-coded label, which includes chip, antenna and bonding wires as a so-called inlay. In some scenarios, the labels made of paper, fabric or plastics are prepared as a paper roll with the inlays laminated between the rolled carrier and the label media for use in specially designed printer units.

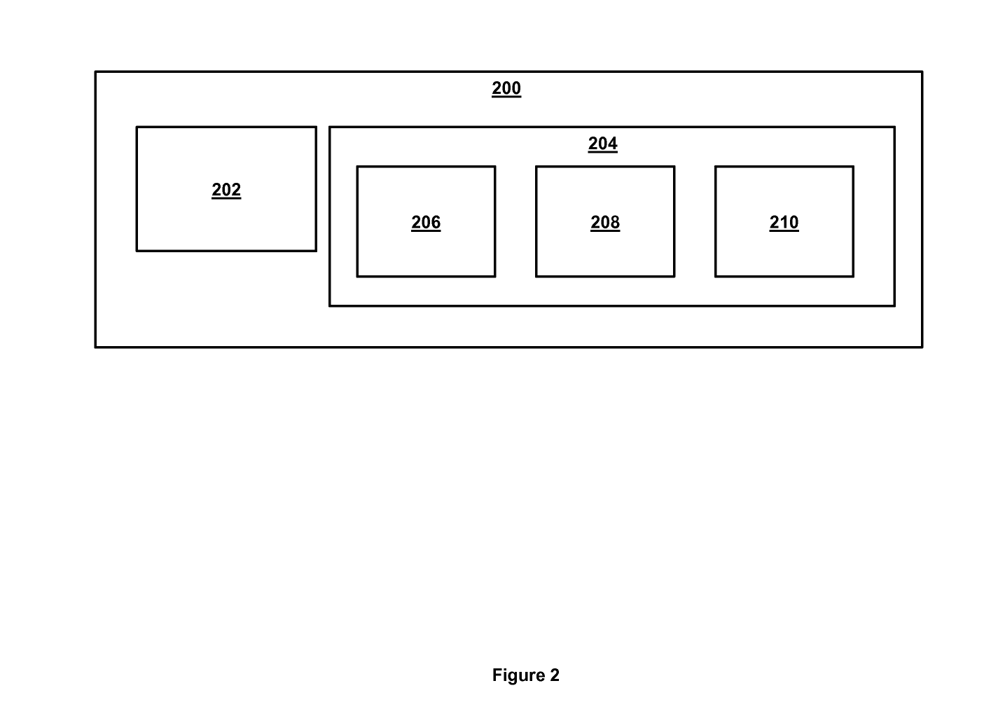

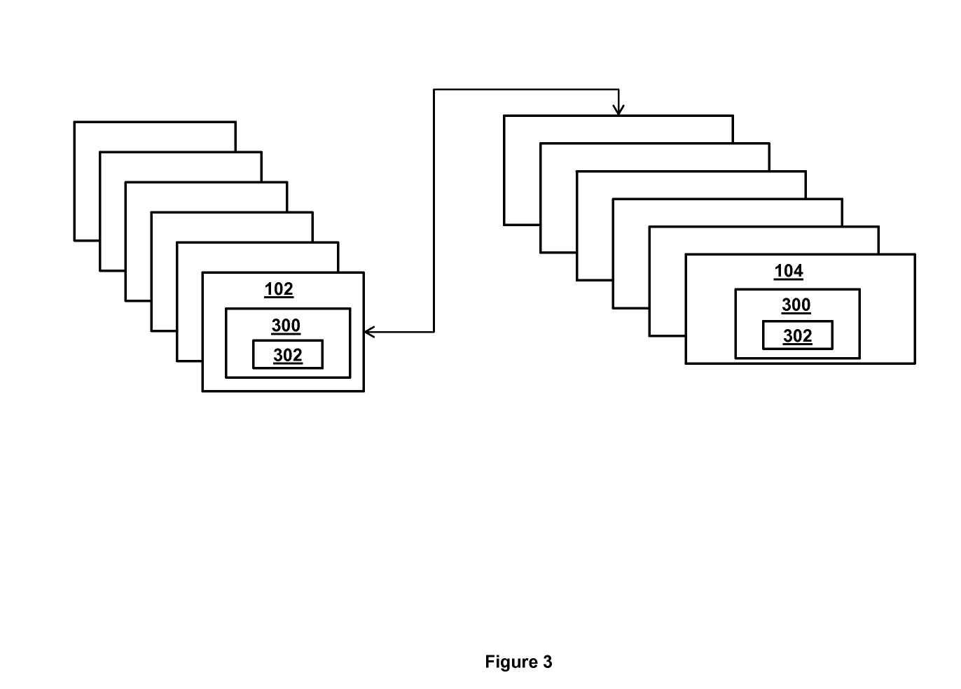

FIG. 2 depicts a detailed block diagrammatic representation of the retro-coupled, proprietary and custom-designed smart labels (or tags) for labeling or tagging the passive and active devices or objects, thereby facilitating realizing IOEA or WOEA, for connecting everything and Anything to Anyone, Anytime, Anywhere, Anyway (5 A's) with enhanced inter-object and human-object interactivity, according to one or more embodiments.

With reference to FIGS. 1-2, in some embodiments, the one or more passive and active objects (or devices) 102 and 104, of FIG. 1, are also at least one of communicably, operably coupled, and a combination thereof, to the network subsystem 108, of FIG. 1, via usage of the at least one of retro-coupled, proprietary and custom-designed physical and virtual smart object tags (or labels) (not shown here explicitly).

As depicted in FIG. 2, in some embodiments, the retro-coupled, proprietary and custom-designed smart label or tag 200 comprises a transponder 202 and a label 204. Specifically, the label 204 comprises an Integrated Circuit (IC) (or chip) 206, an antenna 208 and bonding wires 210 collectively referred to as an inlay. The transponder (transmitter-responder) 202 facilitates emitting an identifying signal in response to an interrogating received signal.

The antenna 208 facilitates converting electric power into radio waves, and vice versa. The antenna 208 is used with a radio transmitter or radio receiver (not shown here explicitly). In operation during transmission, a radio transmitter supplies an electric current oscillating at radio frequency, i.e. a high frequency alternating current (AC), to the terminals of the antenna 208, and the antenna 208 radiates the energy from the current as electromagnetic waves (radio waves). In operation during reception, the antenna 208 intercepts some of the power of an electromagnetic wave in order to produce a tiny voltage at the terminals, which is applied to the radio receiver for amplification.

In some embodiments, for example, and in no way limiting the scope of the invention, the types of smart labels are at least of chip labels, printable labels and electronic labels. Specifically, customization of the smart labels is available with chip cards. In some scenarios involving use in credit cards, combinations of magnetic stripes with RFID chips are used.

In some scenarios involving deployment of the printable labels and printed smart tags collect information autonomously and process the same. For instance, some multilayer tags comprising printed transistors combine battery power worth a year, sensors and a small display to a temperature record of perishable food and medications.

In some embodiments, design, creation and use of retro-coupled, proprietary and custom-designed smart labels (or tags) in the form of stickers capable of being pasted on the physical objects or devices, thereby preventing tampering, peeling or removal and reuse of the sticker-like retro-coupled, proprietary and custom-designed smart labels (or tags) is disclosed, in accordance with the principles of the present invention. Specifically, creation and use of at least one of a tamper-proof, tamper-evident, tamper-resistant patterned, and a combination thereof, multi-layered sticker-like retro-coupled, proprietary and custom-designed smart labels (or tags) is disclosed, in accordance with the principles of the present invention. For example, and in no way limiting the scope of the invention, in some instances, a dual-layered sticker-like retro-coupled, proprietary and custom-designed smart label (or tag) comprises 1) a first layer comprising at least one of a first unique tamper-proof, tamper-evident, tamper-resistant pattern, and a combination thereof, and, or with, a first unique intra-layer pattern alignment therefor, and 2) a second layer comprising at least one of a second unique tamper-proof, tamper-evident, tamper-resistant pattern, and a combination thereof, and, or with, a second unique intra-layer pattern alignment therefor. Specifically, the first layer comprising at least one of the first unique tamper-proof, tamper-evident, tamper-resistant pattern, and the combination thereof, and, or with, the first unique intra-layer pattern alignment therefor, and 2) the second layer comprising at least one of the second unique tamper-proof, tamper-evident, tamper-resistant pattern, and the combination thereof, and, or with, the second unique intra-layer pattern alignment therefor, in combination, or unison, possess a unique inter-layer, i.e. first-is-to-second layer, relative pattern alignment, thereby facilitating misalignment (auto-misalignment) of the unique inter-layer relative pattern alignment by virtue of design of the dual-layered sticker-like retro-coupled, proprietary and custom-designed smart labels (or tags) upon tampering, peeling or removal, in turn, at least one of preventing attempted or forced re-alignment for reuse as well as hampering forced reuse by virtue of material used in, or for, the dual-layered sticker-like retro-coupled, proprietary and custom-designed smart labels (or tags).

In some embodiments involving deployment of proprietary and custom-designed smart labels (or tags) comprising the unique, encrypted and online network-based Identification (ID) codes, for instance at least one of alphabetical, numerical, special characters, and combinations thereof, imprinted thereupon or therein, and serving as a retrofit to physical objects or devices is disclosed, in accordance with the principles of the present invention.

FIG. 3 depicts a block diagrammatic representation of the proprietary and custom-designed smart labels (or tags) comprising unique, encrypted and online network-based Identification (ID) codes imprinted thereupon or therein, and serving as a retrofit to physical objects or devices, according to one or more embodiments.

As depicted in FIG. 3, in some embodiments, each of the passive and active devices 102 and 104 are retrofitted with a proprietary and custom-designed smart label (or tag) 300 comprising a unique, encrypted and online network-based Identification (ID) code 302 imprinted therein or thereupon.

For example, and in no way limiting the scope of the invention, the proprietary and custom-designed smart label (or tag) 300 is at least one of a barcode, security, smart label, and the like. In some scenarios, the proprietary and custom-designed smart label (or tag) 300, for instance the barcode label, comprises unique, encrypted and online network-based Identification (ID) code 302, for instance a barcode, which is imprinted on the barcode label. The barcode 302 is used for at least one of identification of a given product, thereby facilitating traceability in freight packages, and brand authentication and protection thereof. In some scenarios, the security labels are used for anti-counterfeiting, brand protection, tamper-evident seals, anti-pilferage seals, etc. The security labels combine a number of overt and covert features to make reproduction difficult. The use of security printing, holography, embossing, barcodes, RFID chips, custom printing, weak (or weakened) backings, etc. is common. The security labels are used for authentication, theft reduction, and protection against counterfeit and are commonly used on ID cards, credit cards, packaging, and products from CDs to electronics to clothing. In some scenarios, the types of smart labels used are at least of chip labels, printable labels and electronic labels. Specifically, customization of the smart labels is available with chip cards. In some scenarios involving use in credit cards, combinations of magnetic stripes with RFID chips are used. In some scenarios involving deployment of the printable labels, printed smart tags collect information autonomously and process the same. For instance, some multilayer tags comprising printed transistors combine battery power worth a year, sensors and a small display to a temperature record of perishable food and medications.

With reference to FIGS. 1 and 3, in use, the object Identification (ID) code encrypter/decrypter 134, of the object Identity (ID) management application 130 of FIG. 1, encrypts or encodes the unique online network-based Identification (ID) codes 302 generated by the object Identification (ID) code generator 132, of the object Identity (ID) management application 130 of FIG. 1, in a manner such that at least one of A) the characters, for instance at least one of alphabetical, numerical, special characters, and combinations thereof, of the unique online network-based Identification (ID) codes 302 by virtue of the code encryption/encoding algorithm used therefor, and B) the design or pattern of the unique online network-based Identification (ID) codes 302 by virtue of the design or pattern encryption/encoding method or technique used therefor facilitate at least one of concealing and obscuring any information on the proprietary and custom-designed smart label (or tag) 300.

With reference to FIGS. 1 and 3, further, in use, in some scenarios a user utilizes a camera (not shown here explicitly) of the at least one of portable and wearable computing and communications devices 106 to partially manually or automatically capture or scan the unique, encrypted and online network-based Identification (ID) code 302, for instance at least one of a character (or textual) code and design (or pattern or graphical) code. Upon scanning or capturing, the unique, encrypted and online network-based Identification (ID) code 302 is deciphered or decrypted using the object Identification (ID) code encrypter/decrypter 134, of the client-side object Identity (ID) management application 130 downloaded, installed and running on the at least one of portable and wearable computing and communications devices 106 of FIG. 1, based on appropriate decryption algorithms. In some alternate scenarios, a user manually feeds or inputs the unique, encrypted and online network-based Identification (ID) code 302, for instance at least one of the character (or textual) code and design (or pattern or graphical) code, via accessing a customized GUI offered or provided by the front end application, for instance the proprietary client-side object Identity (ID) management application 130, downloaded, installed and running on the at least one of portable and wearable computing and communications devices 106 of FIG. 1, and which GUI is rendered on the first display subunit 122 coupled to the first Input/Output (I/O) subunit 116 thereof. Upon feeding or inputting, the unique, encrypted and online network-based Identification (ID) code 302 is deciphered or decrypted using the object Identification (ID) code encrypter/decrypter 134, of the client-side object Identity (ID) management application 130 downloaded, installed and running on the at least one of portable and wearable computing and communications devices 106 of FIG. 1, based on appropriate decryption algorithms. Upon decryption or deciphering the unique, encrypted and online network-based Identification (ID) code 302 at least one or captured (or scanned) and fed, the decrypted or deciphered code is used index or search or scan the backend database 160, thereby facilitating accessing and retrieving data or information linked to the fed or captured (or scanned) unique, encrypted and online network-based Identification (ID) code 302 imprinted upon or in a given physical object Identification (ID) tag (or label) corresponding to a given physical object or device. For example, and in no way limiting the scope of the invention, the backend database 160 is a secure, online database. In some scenarios, in use, a user can at least one of upload and download multimedia data or information, for instance at least one of audio, text, video, visual (or image or picture), and combinations thereof as well as the unique, encrypted and online network-based Identification (ID) codes 302 imprinted upon or in one or more physical object Identification (ID) tags (or labels) corresponding to one or more physical objects or devices.

With reference to FIGS. 1 and 3, in some embodiments, for example, and in no way limiting the scope of the invention, the front end application, for instance the proprietary client-side object Identity (ID) management application 130, is at least one of a mobile application (mobile app or app) and web-based application (or web app). In use, the object Identification (ID) code scanner or receiver 162 of the proprietary client-side object Identity (ID) management application 130 A) at least one of downloaded, installed and running as an online mobile app on the at least one of portable and wearable computing and communications devices 106, and B) at least one of downloaded, installed and running as a online web app on at least one of fixed and semi-portable computing and communications devices 106 is used to at least one of capture (or scan) using a camera thereof and feed (or input) the unique, encrypted and online network-based Identification (ID) codes 302. Further, in use, the object Identification (ID) code encrypter/decrypter 134 of the front end application, for instance the proprietary client-side object Identity (ID) management application 130, is used to decrypt/decipher the at least one of captured (or scanned) and fed (or inputted) unique, encrypted and online network-based Identification (ID) codes 302. Still further, in use, the front end application, for instance the proprietary client-side object Identity (ID) management application 130, is used to access the backend database 160 using the DBMS 158 and the backend application thereof, for instance the proprietary server-side object Identity (ID) management application 130, in conjunction with the login credentials of users, for instance the User Identification or Identifier (UID) and Password (PWD), and the successfully decrypted/deciphered Identification (ID) codes corresponding to one or more unique, encrypted and online network-based Identification (ID) codes 302. Upon successfully accessing the backend database 160, users can perform one or more desired operations on the backend database 160, such as at least one of uploading desired information or data thereto and downloading as well as retrieving desired information or data therefrom.

In some embodiments, design and implementation of unique, encrypted, online or offline network-based Identification (ID) codes with one or more qualitative parameters-of-merit, such as at least one of tamper-resistant, tamper-proof, tamper-evident, openly and securely accessible, non-reusable, and combination thereof applicable in one or more real-time scenarios, is disclosed, in accordance with the principles of the present invention.

In general, human interactions with one or more objects in the ambiances or surroundings is based on one or more human senses, namely sight or vision, hearing or audition, taste or gestation, smell or olfaction, touch or somatosensation. Specifically, the sensory ecology, perception and interactions allow humans to gain useful information in connection with objects or things, such as color, texture or geometry, size or dimensions, weight, material or matter, odor, and the like. However, many manufactured objects, for instance packaged food items, mechanical and electrical goods, still have labels or tags stuck, printed, embedded, embossed or engraved thereupon so as to provide additional information in connection with the object that is not discernible via human senses or analytical thinking. For example, product labels, Structured Product Labels (SPLs), packaging insets, Country of Origin Labels (COOLs), European Union (EU) energy labels, nutritional facts labels, warning labels and mandatory labels. Specifically, nutritional facts labels provide nutritional content or list of ingredients on consumer products and packaged foods. Likewise, textile labels comprise the size, the pesticide registration number, statement of ingredients, storage and disposal information, method of washing, and the like.

However, problems with all the aforementioned labels are that they lack additional desirable information in connection with the objects or things that is not easily available to or accessible by end consumers. For instance, the additional desirable information may comprise data or information in connection with the time (or when), location (or where) and method (or process or how) of manufacturing of the item or object, the time (or when), location (or where) and method (or process or how) of packaging thereof, the time (or when), location (or where) and method (or process or how) of storage and shipping or transit thereof, any and all manufacturing defects, issues and flaws therein, feedback, reviews, comments or opinions therefor from peer users or consumers of relevant competing items, objects or products, pricing, buying, purchasing and selling trends thereof, and the like. As a consequence, all of the aforementioned information is only available to and accessible by the manufacturer, seller or distributor of the products, and not to end consumers at the Point of Sale (POS). One or more solutions to the aforementioned problems is deployment of detection and tracking systems and methods, such as Radio Frequency Identification (RFID) and Near Field Communication (NFC) tags, and the like, to identify or detect and track objects or things, and access and retrieve information in connection with the objects or things via usage of specialized electronic readers and networked or shared databases. However, the aforementioned solutions are only deployed by the manufacturer, seller or distributor of the products. Thus, end consumers shall neither have the aforementioned information at the POS, nor later.

Another major problem is duplication or imitation of Identifier (or Identification or ID) tags, and Identification codes at least one of written, printed, embedded, embossed and engraved thereupon, in illegally produced copies of products, or counterfeit products, thereby rendering ascertaining the genuity or authenticity of the product a difficult task for end consumers. One partial solution to the aforementioned problem is accessing consumer reviews on the products from the Internet subsequent to providing specific details on the products comprising item numbers, manufacturer codes, and the like. However, the foregoing partial solution is onerous, ambiguous, unreliable and time-consuming.

Thus, advantageously, in some embodiments, the present invention facilitates generation and assignment of the unique, encrypted and online or offline network-based Identification (ID) codes with one or more qualitative parameters-of-merit, such as at least one of tamper-resistant, tamper-proof, tamper-evident, openly and securely accessible, non-reproducible, non-reusable, retro-coupled, economical, user-friendly, and combination thereof, to one or more passive or active physical objects or devices or things, in turn, facilitating managing objects and enhanced inter-object and human-object interactivity using networked electronic devices, in accordance with the principles of the present invention.

In some scenarios involving Authentication, Authorization and Accounting (AAA) of personnel in at least one of public spaces and private places, Identification (ID) cards with personal photographs and other personal information embedded with at least one of Radio Frequency Identification (RFID), Near Field Communication (NFC), barcodes, Quick Response (QR) codes, digital watermarking, special markings visible under Ultra Violet (UV) light, for instance UV marker, holograms, and the like, are often used to manage, i.e. monitor access and permissions. In some scenarios, custom-designed reading (or scanning) devices and human sentinels/sentries are often required to scan, authenticate and authorize the ID cards. However, ID cards those that are subject to visual (or manual) authentication and authorization are prone to tampering and easy duplication, for instance affixing a wrong or false photograph to a given ID card.

In some embodiments, Authentication, Authorization and Accounting (AAA) of personnel in at least one of public spaces and private places using the unique, encrypted and online or offline network-based Identification (ID) codes is disclosed, in accordance with the principles of the present invention.

With reference to FIGS. 1 and 3, in some scenarios involving AAA of personnel, the unique, encrypted and online or offline network-based Identification (ID) codes 302 are at least one of covertly embedded, embossed, engraved, written and printed on Identification (ID) cards (not show here explicitly), thereby facilitating managing objects and enhanced inter-object and human-object interactivity using networked electronic devices, in accordance with the principles of the present invention. In use, one or more interested users scan the unique, encrypted and online or offline network-based Identification (ID) codes 302 at least one of covertly (or imperceptibly) embedded, embossed, engraved, written and printed on the Identification (ID) cards using at least one of a proprietary and authorized mobile and web-based application, for instance the proprietary client-side object Identity (ID) management application 130, downloaded and installed on at least one of portable and wearable computing and communications devices 106, owned and operated by the interested users. Upon scanning the unique, encrypted and online or offline network-based codes 302 coupled to the Identification (ID) cards, the interested users are able to access, retrieve and download up to date information associated with the unique, encrypted and online or offline network-based codes 302 coupled to the Identification (ID) cards, for instance the name of the person holding the ID card, photograph, status and the like. In some worst case scenarios involving swapping the photographs of the original (or true) owners or holders of the genuine or authentic ID cards with the photographs of quacks on forged ID cards, the unique, encrypted and online or offline network-based codes 302 at least one of covertly (or imperceptibly) embedded, embossed, engraved, written and printed on the forged ID cards is subjected to scanning using the proprietary client-side object Identity (ID) management application 130, downloaded and installed on at least one of portable and wearable computing and communications devices 106, owned and operated by the interested users. Upon scanning, the originally recorded information, for instance the original name, photograph and status, in connection with the genuine or authentic ID cards are accessed, retrieved and downloaded, thereby facilitating analysis of the originally recorded information, for instance the original name, photograph and status, vis-à-vis the information on the forged ID cards, thereby facilitating full-proof AAA of the personnel.

In certain circumstances involving authentication of consumer goods and products, widespread and incessantly, rising availability of counterfeit consumer goods, counterfeit medicinal products or counterfeit medications, such as medicines, bottled water, luxury goods, for instance sun glasses or watches, leads to adverse financial, efficiency, performance, and health impacts on the consumers thereof, thereby posing a major problem. Adding to the foregoing problem are advances in packaging and printing technology, thereby rendering easy replication or imitation in packaging and labeling counterfeit products. As a consequence, differentiating counterfeit consumer goods, counterfeit medicinal products or counterfeit medications from genuine or authentic goods becomes difficult task for end consumers. Some solutions suggest or recommend usage of special product seals or holograms. However, with recent advances in counterfeiting technologies renders the use of the special product seals or holograms as a preventive anti-counterfeiting technique proves to be an ineffective deterrent.

Advantageously, in some embodiments, the system and method of the present invention facilitate AAA of consumer products, in accordance with the principles of the present invention. Specifically, in some scenarios, the system and method of the present invention facilitate managing anti-counterfeiting in connection with products or goods, and adverse impacts thereof, thereby facilitating detecting and analyzing counterfeit products or goods, in turn facilitating implementation of preventive and curative anti-counterfeiting measures therefor, in accordance with the principles of the present invention. For example, and in no way limiting the scope of the invention, the counterfeit products or goods are at least one of counterfeit consumer goods and medications, thereby leading to adverse financial, efficiency, performance, and health impacts on the consumers thereof.

Still advantageously, in some embodiments, the system and method of the present invention facilitates managing anti-counterfeiting in connection with products or goods packaging and labeling, and adverse impacts thereof, thereby facilitating detecting and analyzing counterfeit products or goods packages and labels, in turn facilitating implementation of preventive and curative anti-counterfeiting measures therefor, in accordance with the principles of the present invention. In some embodiments, the system and method of the present invention facilitates differentiating between counterfeit and authentic products or goods, in accordance with the principles of the present invention. In some scenarios involving usage of special product seals or holograms, the system and method of the present invention facilitates avoiding replication of the seals, thereby serving as an effective deterrent.

With reference to FIGS. 1 and 3, in use, the unique, encrypted and online or offline network-based Identification (ID) code 302 is generated for each item (or product or object) and assigned thereto. The generated and assigned unique, encrypted and online or offline network-based Identification (ID) code 302 corresponding to the item (or product or object) facilitates linking the same to a cloud-based, online (or networked or shared) database, for instance the backend database 160 using the front end application, for instance the proprietary client-side object Identity (ID) management application 130, backend application, for instance the proprietary server-side object Identity (ID) management application 130. The backend database 160 comprises one or more distinct records comprising one or more distinct attributes in connection with each item (or product or object). Further, in use, a user uses at least one of the portable and wearable computing and communications device 106 to access and retrieve the record corresponding to a given item (or product or object) via querying the backend database 160 using the front end application, for instance the proprietary client-side object Identity (ID) management application 130, backend application, for instance the proprietary server-side object Identity (ID) management application 130, correspondingly downloaded, installed and running on the at least one of the portable and wearable computing and communications device 106 and the at least one of a networked and cloud-based secure host computing unit 136. For example, and in no way limiting the scope of the invention, the distinct record corresponding to each item (or product or object) comprises one or more distinct attributes, such as the manufacturer details, for instance the name of the manufacturer, date, time and location thereof, packaging, labeling, supply, distribution chain, and the like. Noteworthy here is the fact that upon activation of the generated and assigned unique, encrypted and online or offline network-based Identification (ID) code 302 corresponding to the given item (or product or object) by the manufacturer or producer, the record corresponding to the given item (or product or object) is uploaded to the backend database 160. However, in some other scenarios, upon activation of the generated and assigned unique, encrypted and online or offline network-based Identification (ID) code 302 corresponding to the given item (or product or object) during entry of the given item (or product or object) into a given distribution channel or supply chain, the record corresponding to the given item (or product or object) is uploaded to the backend database 160.

Advantageously, the accessed and retrieved record corresponding to the given item (or product or object) facilitates a consumer to make an informed decision or choice in connection with the given item (or product or object) as well as differentiate counterfeit item or product or object from genuine counterpart thereof.

Still advantageously, the unique, encrypted and online or offline network-based Identification (ID) code 302 at least one of covertly (or imperceptibly) embedded, embossed, engraved, written and printed on the corresponding physical Identification (ID) tag or label therefor coupled to a given item or product or object can be at least one of deactivated by the consumer using the proprietary client-side object Identity (ID) management application 130 and physically (or manually) destroyed by at least one of a user and seller, upon purchase or consumption of the given item or product or object.

In some alternative scenarios, the unique, encrypted and online or offline network-based Identification (ID) code 302 at least one of covertly (or imperceptibly) embedded, embossed, engraved, written and printed on the corresponding physical Identification (ID) tag or label therefor coupled to a given item or product or object may be automatically deactivated subject to expiry or lapse of at least one of a time-dependent and time-sensitive pre-defined limit. In some scenarios, the at least one of time-dependent and time-sensitive pre-defined limit has at least one of a fixed and variable, which is explicitly definable by at least one of maker and authorized seller. Upon at least one of manual and automatic deactivation of the unique, encrypted and online or offline network-based Identification (ID) code 302, the unique, encrypted and online or offline network-based Identification (ID) code 302 is rendered useless for reuse by at least one of authorized return and unauthorized new user. In some scenarios, each individual unique, encrypted and online or offline network-based Identification (ID) code 302 is equipped or adapted to be at least one of manually deactivated by at least one of seller and maker at any point in time, and automatically deactivated subject to expiry or lapse of at least one of a time-dependent and time-sensitive pre-defined limit, thereby rendering counterfeiting the unique, encrypted and online or offline network-based Identification (ID) code 302 and affixing (or coupling) the same to a counterfeit object (or item or product) of an original counterpart thereof incurring prohibitive cost and high probability of failure, thus resulting in reduction in counterfeiting as a curative or reactive technique.

In some embodiments, the unique, encrypted and online or offline network-based Identification (ID) codes 302 are encrypted in a manner such that the information linked thereto, or in connection therewith, can be at least one of uploaded and accessed only by authorized users using the front end application, for instance the proprietary client-side object Identity (ID) management application 130. In some scenarios, in use, the information acquired by scanning (or capturing) the physical Identification (ID) tag comprising unique, encrypted and online or offline network-based Identification (ID) codes 302 coupled to a given item (or product or object) may be used by at least one of manufacturers, makers, authorized sellers, distributors and marketers to know about at least one of “Who scanned the given item (or product or object)?,” “Where?,” “Why?,” “When?” and combinations thereof, thereby facilitating the at least one of manufacturers, makers, authorized sellers, distributors and marketers to at least one of develop, refine, enhance existent products, restrict, recall (call off), ban sale of at least one of defective, less in demand, outdated, out of season (or untimely) and lower perceived quality products in at least one of one or more give geographic regions and one or more periods of time, and marketing campaigns therefor.

In certain situations involving medical triage and emergency patient management, in the event that emergency patients arrive in the hospitals in the wake of the occurrence of accidents or other unwanted, unexpected and untoward incidents a lot of information in connection with the emergency patients is demanded by the emergency department, such as emergency nurses and operating staff. However, the emergency patients, and family attendants therefor, fail to provide the information in connection with the emergency patients reliably, accurately, completely and in a timely manner. The failure in providing the information in connection with the emergency patients is owing to the fact that the emergency patients, and family attendants therefor, are at least one of under panic, in a state of urgency and not in the right state (or frame) of mind, or the required or demanded information is not readily available. For example, the information in connection with the emergency patients comprises the first, middle and last name, Date of Birth (DOB), primary care physician name, address, city, country, state/province, postal or zip code, unique medical record number, emergency contacts, telephone number, gender, advance directives, marital status, Social Security Number (SSN), unique driving license number, blood type, organ donor, language or mother tongue, faith or religion and unique corporate medical identification number; healthcare information updation date, for instance date last modified or updated; multiple allergy information, for instance allergy type, name of allergen, reaction, source (personal or discharge summary or clinical note) and severity; multiple medications information, for instance generic name and brand name; patient identity verification information, for instance Personal Identification Number(s) (PINs), patient photo or biometric information, identity management information; multiple medical problems information, for instance diagnosis or problem description, expression of problem; multiple surgeries and procedures information, for instance description, date, re-route pipeline to additional data; first responder, Federal Emergency Management Agency (FEMA)/Fracturing Responsibility and Awareness of Chemicals (FRAC) access information, for instance smart healthcare card reading authority, date stamp, audit trail and time limit; insurance or guarantor information, for instance multiple insurance dates, carrier, plan, policy, subscriber name, guarantor data, first, middle and last name, relationship to subscriber and address details; customized additional patient information, for instance implanted devices, pacemakers, artificial valves and defibrillators; customized payment information, for instance AMEX®/VISA®/MASTERCARD® credit/debit card, Health Savings Account/Health Spending Account (HSA) and social healthcare/insurance program. Some solutions to the foregoing problem suggest or recommend usage of Electronic Medical or Health Records (EMRs or EHRs) and smart health cards. However, in unknown, unexpected, unwanted and untimely situations the emergency patients, and family attendants therefor, generally tend to unintentionally forget to carry the smart health cards or fail to recapitulate one or more unique keys required to access and retrieve the information stored in the EMRs or EHRs. In some worst case scenarios involving occurrence of unknown, unexpected, unwanted and untimely situations of emergency in at least one of unknown, unidentified and unreachable regions or locations or areas, the emergency patients may be unfamiliar of, or to, the unknown, unidentified and unreachable regions or locations or areas, or may not be accompanied by the family or known attendants therefor, thereby rendering availability of reliable, accurate and complete demanded or required information in a timely manner a complicated or impossible task.

With reference to FIGS. 1 and 3, advantageously, in some embodiments, the unique, encrypted and online or offline network-based Identification (ID) codes 302 is affixed to one or more personal belongings of the emergency patient, for instance a wallet, purse or phone. In use, the unique, encrypted and online or offline network-based Identification (ID) codes 302 is scanned using the front end application, for instance the proprietary client-side object Identity (ID) management application 130 downloaded, installed and running on at least one of portable and wearable computing and communications device 106. Upon scanning the unique, encrypted and online or offline network-based Identification (ID) codes 302, the information in connection with the emergency patient is accessed and retrieved, which information may have been uploaded by at least one of the emergency patient autonomously and the personal (or family) doctor thereof previously by using the unique, encrypted and online or offline network-based Identification (ID) codes 302 as the primary key in the backend database 160. In some scenarios involving presence or availability of the aforementioned information in connection with the emergency patient in a readable form, for instance as a physical printed label, on the personal belongings of the emergency patient, the aforementioned information may be insecure and impractical. Specifically, the aforementioned information is impractical owing to the fact that the aforementioned information subject to change with time, for instance the medical history may change. Likewise, the aforementioned information is insecure owing to the fact that the aforementioned information is prone or susceptible to theft, and unauthorized access and use subsequently. Thus, advantageously, in some scenarios, the aforementioned information may be safely or securely stored in an online database, for instance the backend database 160, thereby facilitating access to only authentic, authorized and accountable users, for instance friends, family members, social contacts, colleagues, family doctors, and family lawyers, using the front end application, for instance the proprietary client-side object Identity (ID) management application 130 downloaded, installed and running on at least one of portable and wearable computing and communications device 106 and the unique, encrypted and online or offline network-based Identification (ID) codes 302 as a primary key for access of the aforementioned information and retrieval thereafter. In operation, the front end application, for instance the proprietary client-side object Identity (ID) management application 130 downloaded, installed and running on at least one of portable and wearable computing and communications device 106 maintains records of accesses to the backend database 160, for instance, “Who accessed the aforementioned information?,” “Where?,” “Why?,” “When?” and combinations thereof, and track the same. In some scenarios, the owner (or targeted user) of the unique, encrypted and online or offline network-based Identification (ID) codes 302 is affixed to one or more personal belongings of the owner may manage distinct owner-defined explicit access levels, i.e. define, assign or allocate, modify, to the aforementioned information subject to the type of targeting user, for instance friends, family members, social contacts, colleagues, family doctors, family lawyers and general public. In some embodiments, the personal physical belongings, things or objects, for instance the cell phones, keys, of the owners and the unique, encrypted and online or offline network-based Identification (ID) codes 302 affixed thereto may facilitate in easily detecting (or finding) and retrieving lost items instead of contacting lost and found entities.

In some applications involving people detection and tracking, there is often a need for targeting users to detect and track the locations or whereabouts of targeted users, such as peers, family members, for instance spouse, children, teenage girls and elderly, friends, colleagues, social media contacts, and the like. Alternately, in some scenarios, the targeted users, such as peers, family members, for instance spouse, children, teenage girls and elderly, friends, colleagues, social media contacts, and the like may need to update the locations or whereabouts to the targeting users. For example, in some scenarios involving travelling at least one of timely and untimely on at least one of land, air and water from and to at least one of unknown, remote, close and unsafe source and destination locations, respectively, the targeted users, such as peers, family members, for instance spouse, children, teenage girls and elderly, friends, colleagues, social media contacts, and the like may need to periodically send messages to update the locations or whereabouts to the targeting users. One simple and crude solution to the aforementioned problem is sending or transmission of at least one text, voice, visual, video messages, and a combination thereof, for instance multimedia messages from and to commonly available portable computing and communications devices, such as mobile or cell phones. However, the aforementioned solution is neither reliable, not practical in the event that the targeted users are required to update multiple targeting users at least one of selectively, randomly and in a customized-fashion with different message content, different profiles, at different locations in different time zones and in different ways.

With reference to FIGS. 1 and 3, advantageously, in some embodiments, in use, the front end application, for instance the proprietary client-side object Identity (ID) management application 130 downloaded, installed and running on the at least one of portable and wearable computing and communications device 106, owned and operated by the user, periodically accesses the location information. For example, and in no way limiting the scope of the invention, the location information is based on GPS, mobile phone tracking, and the like. Further, in use, the location information is uploaded to an online database, for instance the backend database 160, indexed by the unique, encrypted and online or offline network-based Identification (ID) code 302 affixed to the at least one of portable and wearable computing and communications device 106, owned and operated by the user. Upon uploading, multiple users can subsequently access the uploaded location information. In some scenarios, in the event that multiple users are travelling in a group, for instance a long distance journey via road in a bus, a common identification code, for instance the unique, encrypted and online or offline network-based Identification (ID) code 302 is assigned to the bus. Thus, all the co-travelers in the bus can publish the location information using the front end application, for instance the proprietary client-side object Identity (ID) management application 130 downloaded, installed and running on the at least one of portable and wearable computing and communications device 106 to a common database, for instance the backend database 160, thereby facilitating alleviating issues in connection with cell phone network coverage and battery life therefor. In some scenarios, an online database, for instance the backend database 160, and the front end application, for instance the proprietary client-side object Identity (ID) management application 130 downloaded, installed and running on the at least one of portable and wearable computing and communications device 106 facilitate collation the information in connection with the co-travelers in the bus, thereby facilitating hosting the information uploaded by the co-travelers, such as comments, video, audio, voice, visuals, and a combination thereof, for instance multimedia, in connection with the group travel. Upon completion of the journey, the unique, encrypted and online or offline network-based Identification (ID) code 302 assigned to the bus is deactivated using the front end application, for instance the proprietary client-side object Identity (ID) management application 130 downloaded, installed and running on the at least one of portable and wearable computing and communications device 106 via terminating the updation of location information thereby.

In some embodiments involving public surveys, reviews, comments, opinions polls and social commentary, the unique, encrypted and online or offline network-based Identification (ID) code is coupled to each object or thing, for instance a tree, an automobile, a musical instrument and pet, via usage of a physical object Identification (ID) tag or label, thereby providing online identity to the object or thing, in turn facilitating a multiplicity of social interactions both involving and linked to the object or thing, for instance “Human-to-Object” and “Object-to-Object”.

With reference to FIGS. 1 and 3, advantageously in some embodiments, in use, for example, the unique, encrypted and online or offline network-based Identification (ID) code 302, of FIG. 3, is at assigned to a given tree and at least one of embedded, embossed, engraved, printed and written onto a physical Identification tag affixed thereto. In some scenarios, in the event that the tree is scheduled to be subject to cutting, the unique, encrypted and online or offline network-based Identification (ID) code 302 assigned to the given tree and at least one of embedded, embossed, engraved, printed and written onto the physical Identification tag affixed thereto may facilitate any passerby or interested parties to scan the unique, encrypted and online or offline network-based Identification (ID) code 302 and post opinions/suggestions to an online database, for instance the backend database 160, in connection with the given tree. Further, the municipal corporation or city management can access and retrieve all the information uploaded onto the backend database 160 so as to make appropriate decisions. The unique, encrypted and online or offline network-based Identification (ID) code 302 assigned to the given tree and at least one of embedded, embossed, engraved, printed and written onto the physical Identification tag affixed thereto facilitates providing general public an opportunity along with the right context, at the right place and at the right time, or instantly, to make an informed decision by looking at the ambiances, and in turn providing appropriate commentary. In some scenarios involving tagging or labeling at least one of popular and obscure tourist attraction entities, the unique, encrypted and online or offline network-based Identification (ID) code 302, of FIG. 3, is at assigned to a given tourist attraction entity and at least one of embedded, embossed, engraved, printed and written onto a physical Identification tag affixed at least one of in proximity and vicinity thereof. Upon scanning the unique, encrypted and online or offline network-based Identification (ID) code 302, the travelers can provide information in connection with the given tourist attraction entity comprising peer reviews therefor, facts and figures thereof in the public domain, for instance the best or most optimal camera angle and Angle of View (AOV) for photography or videography, and nearby favorite eateries, and the like. In use, the front end application, for instance the proprietary client-side object Identity (ID) management application 130 downloaded, installed and running on the at least one of portable and wearable computing and communications device 106 used to scan the unique, encrypted and online or offline network-based Identification (ID) code 302 and access the information, for instance social commentary, therefor from the backend database 160, provides a filter, which is a higher-order function that processes a data structure, typically a list, in some order to produce a new data structure containing exactly those elements of the original data structure for which a given predicate returns the Boolean value true. The filter facilitates accessing commentary from individuals, groups or based on other preferences.

In some embodiments involving managing shipping records, the unique, encrypted and online or offline network-based Identification (ID) code is coupled to each object or thing or item, via usage of a physical object Identification (ID) tag or label, thereby providing online identity to the object or thing, in turn facilitating scanning, detecting and tracking the item. In use, an online database, from the backend database 160, linked to each of the items is easily updated by authorized personnel along the chain as the items move from the manufacturing floor to the end consumers. For example, in some scenarios, a given local farmer growing organic fruits may wish to allow the end consumers thereof to be able to differentiate the organic fruits from the given local farmer from those grown in a foreign continent and shipped thousands of miles in cold chain. In use, the local farmer assigns the unique, encrypted and online or offline network-based Identification (ID) code 302 to each organic fruit, and which unique, encrypted and online or offline network-based Identification (ID) code 302 is coupled thereto via usage of a physical object Identification (ID) tag or label. Upon scanning, the unique, encrypted and online or offline network-based Identification (ID) code 302 coupled to each organic fruit via usage of the physical object Identification (ID) tag or label, the end consumer is able to access all the information relevant to the fruit, for instance the country of origin, nutritional value, farm policies on fertilizers and pesticides, and the like, thereby facilitating the end consumer to make the right decision based on right information, at the right place and at the right time. For example, in some alternative scenarios, the unique, encrypted and online or offline network-based Identification (ID) code 302, of FIG. 3, is at assigned to a given automobile and at least one of embedded, embossed, engraved, printed and written onto a physical Identification tag affixed thereto. Upon scanning by the authorized users, the unique, encrypted and online or offline network-based Identification (ID) code 302 provides detailed information in connection with the given automobile, for instance ownership, service records, traffic records, and the like. In addition, the service technicians of the given automobile, the traffic cops who inspected the given automobile in the past and the authorized friends, family members and colleagues of the owner of the given automobile can upload information in connection therewith to an online database, the backend database 160.

In some situations involving Authentication, Authorization and Accounting (AAA) of personnel in at least one of public spaces and private places, Identification (ID) cards with personal photographs and other personal information embedded with at least one of Radio Frequency Identification (RFID), Near Field Communication (NFC), barcodes, Quick Response (QR) codes, digital watermarking, special markings visible under Ultra Violet (UV) light, for instance UV marker, holograms, and the like, are often used to manage, i.e. monitor access and permissions. In some scenarios, custom-designed reading (or scanning) devices and human sentinels/sentries are often required to scan, authenticate and authorize the ID cards. However, ID cards those that are subject to visual (or manual) authentication and authorization are prone to tampering and easy duplication, for instance affixing a wrong or false photograph to a given ID card.

In some circumstances involving electronically controlled access to doors or gates require users to punch or type in or input access codes on a given keypad. The access codes may be known to controlled set of people. One solution towards improving secure access is to alter or change the access codes. However, re-communicating the altered or updated access codes to the authorized users, as well as learning and remembering the altered or updated access codes often may not be practical.

In some embodiments, Authentication, Authorization and Accounting (AAA) of personnel in at least one of public spaces and private places are disclosed, in accordance with the principles of the present invention.

In some scenarios involving AAA of personnel, the unique, encrypted and online or offline network-based Identification (ID) codes are at least one of embossed, engraved, embedded, printed and written onto Identification (ID) cards, thereby facilitating human-object interactivity, in accordance with the principles of the present invention. In use, interested users scan the unique, encrypted and online or offline network-based Identification (ID) code 302 using a front end application, for instance the proprietary client-side object Identity (ID) management application 130 downloaded, installed and running on the at least one of portable and wearable computing and communications device 106, owned and operated by the interested users. Upon scanning, the interested users are able to access, retrieve and download up to date information associated with the unique, encrypted and online or offline network-based Identification (ID) code 302 at least one of embossed, engraved, embedded, printed and written onto a given Identification (ID) card, for instance the name of the person holding the ID card, photograph, status and the like. In some scenarios involving swapping the photograph of the original owner or holder of the ID card with the photograph of another person on a forged ID card, the unique, encrypted and online or offline network-based Identification (ID) code 302 at least one of covertly and imperceptibly embossed, engraved, embedded, printed and written onto the given Identification (ID) card is subjected to scanning using the proprietary client-side object Identity (ID) management application 130 downloaded, installed and running on the at least one of portable and wearable computing and communications device 106, owned and operated by the interested users. Upon scanning, the originally recorded information, for instance the original name, photograph and status, in connection with the ID card is accessed, retrieved and downloaded, thereby facilitating analysis of the originally recorded information, for instance the original name, photograph and status, vis-à-vis the information on the forged ID card, thereby facilitating full-proof AAA of the personnel.

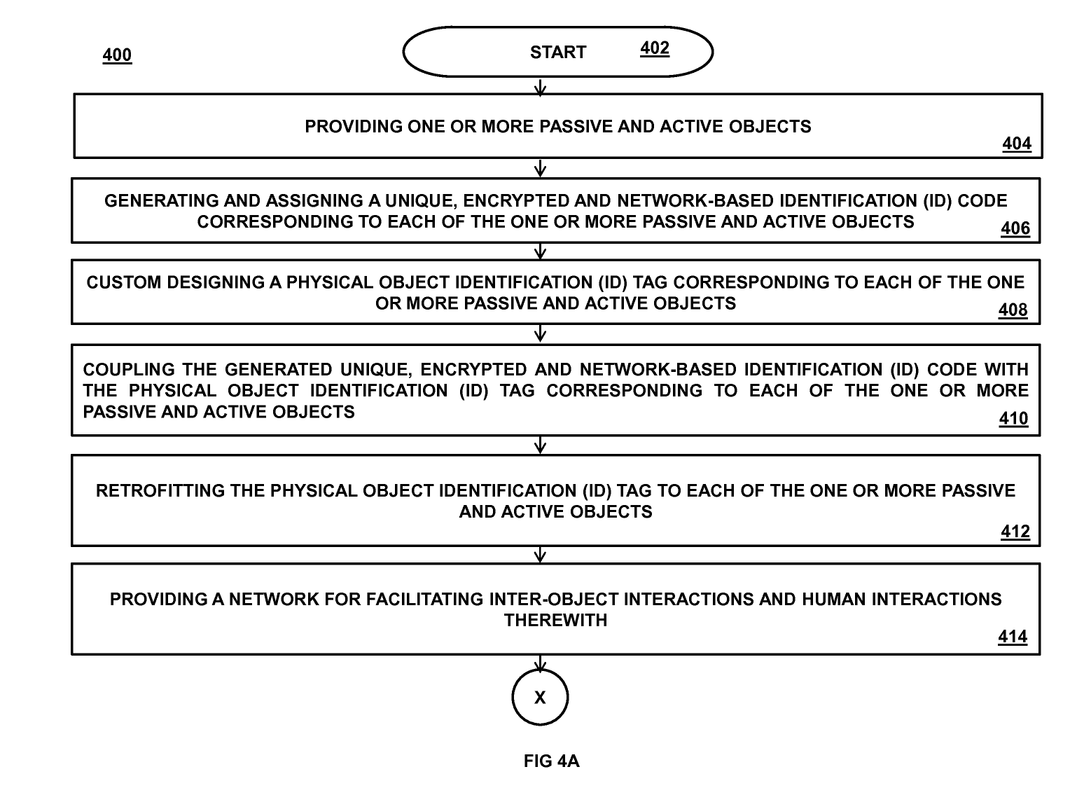

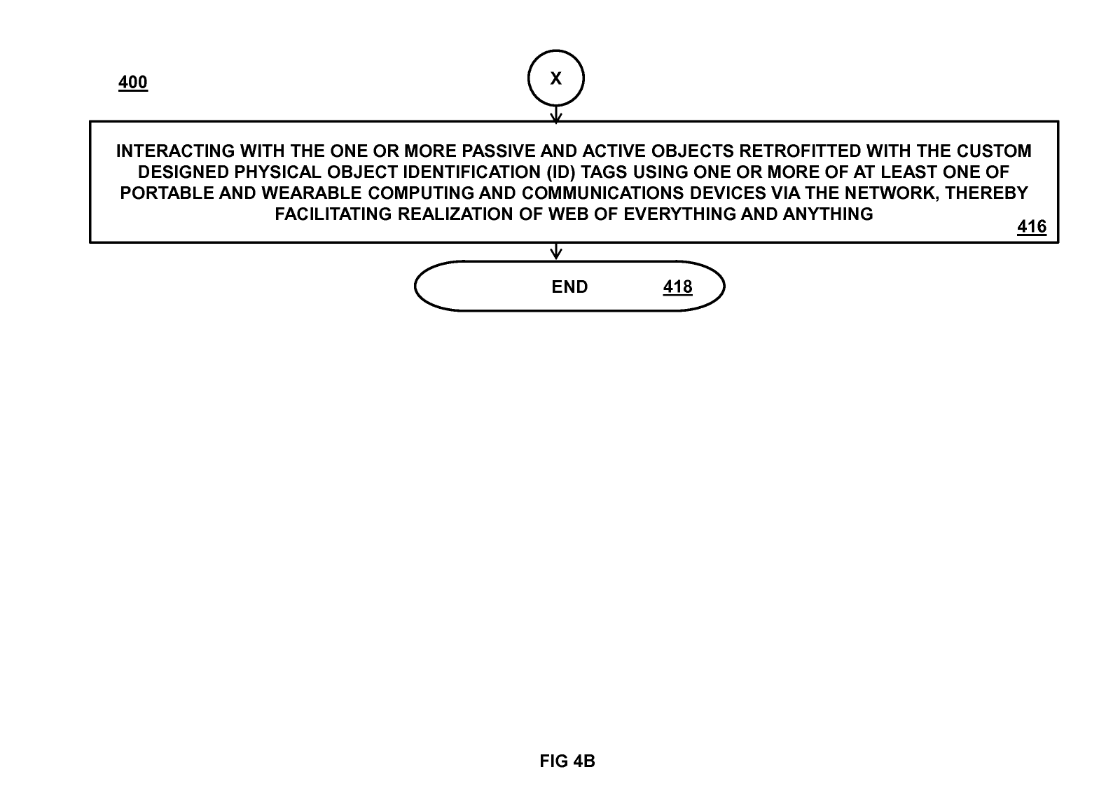

FIGS. 4A-B depict a flow diagram in connection with the method for generating, assigning and implementing the unique, encrypted and online or offline network-based Identification (ID) codes corresponding to the passive and active devices or objects, thereby facilitating enhanced human-object interactivity, according to one or more embodiments.

The method 400 starts at step 402 and proceeds to step 404. At step 404, the method 400 comprises, or facilitates, providing one or more passive and active objects, for instance the one or more passive and active objects, of FIG. 1.

At step 406, the method 400 comprises, or facilitates, generating a unique online or offline network-based Identification (ID) code for a physical object Identification (ID) tag or label correspondingly affixed or coupled to each of the passive and active objects (or devices). For example, and in no way limiting the scope of the invention, the unique online or offline network-based Identification (ID) code is at least one of randomly, sequentially and custom generated.

With reference to FIG. 1, the object Identification (ID) code generator 132 facilitates generating an optical machine-readable representation of data, for instance a barcode, related to each of the passive and active devices or objects 102 and 104. For example, and in no way limiting the scope of the invention, the generated optical machine-readable representation of data, for instance the barcode, is at least one of a One-Dimensional (1-D) (or linear), Two-Dimensional (2-D) (or Matrix) barcode. The generated optical machine-readable representation of data, for instance the barcode, relating to each of the passive and active devices or objects 102 and 104, is hereinafter referred to as a unique online or offline network-based Identification (ID) code.

In some embodiments involving implementation of an encryption scheme, the message data or information, referred to as a plaintext, is encrypted using an encryption algorithm, thereby generating ciphertext that may only be read upon decryption, in accordance with the principles of the present invention. For example, and in no way limiting the scope of the invention, the encryption scheme generally uses a pseudo-random encryption key generated by an algorithm. Hypothetically, the message or ciphertext may be decrypted without possessing the key, but for a well-designed encryption scheme, large computational resources and skill may be required. In some scenarios, an authorized recipient or user may easily decrypt the message or ciphertext with the key provided by the originator to the authorized recipients or users, but not to unauthorized interceptors.

In some scenarios, for example and in no way limiting the scope of the invention, the types of encryption schemes implemented are at least one of A) symmetric-key encryption schemes (or private-key encryption and secure-key encryption), wherein the encryption and decryption keys remains the same, thereby requiring the communicating parties have the same key so as to achieve secure communication, and B) public-key encryption schemes, wherein the encryption key is published for anyone to use and encrypt messages. However, only the receiving party has access to the decryption key that enables messages to be read.

In some embodiments, for example, and in no way limiting the scope of the invention, the generated unique online network-based Identification (ID) codes are encrypted with secure keys only known to the producer or maker using one or more of the secure key encryption schemes. In some embodiments, upon generation and encryption, the unique, encrypted and online network-based Identification (ID) codes are assigned to the corresponding passive and active objects or devices, and at least one of physically coupled thereto via usage of physical object tags (or labels) and logically coupled thereto via usage of virtual object tags (or labels). For purpose of clarity and expediency, the terms “physical object tags (or labels)” and “virtual object tags (or labels)” may be hereinafter intermittently and interchangeably referred to as “physical object Identification (ID) tags (or labels)” and “virtual object Identification (ID) tags (or labels)”, in that order.

The object Identification (ID) code encrypter/decrypter 134 facilitates encrypting the generated unique online network-based Identification (ID) code. Specifically, in operation, the object Identification (ID) code encrypter/decrypter 134 facilitates encrypting/encoding the generated unique online network-based Identification (ID) code in such a way that only authorized users are be able to access, retrieve and read the same. More specifically, in operation, encryption fails to prevent interception autonomously, however denies the message content, for instance the data or information constituting the generated unique, encrypted and online network-based Identification (ID) code, to the interceptor, for instance an unauthorized user.

At step 406, the method 400 further comprises, or facilitates, encrypting the generated unique and online or offline network-based Identification (ID) code. Specifically, in operation, the object Identification (ID) code encrypter/decrypter 134 facilitates encrypting/encoding the generated unique online network-based Identification (ID) code in such a way that only authorized users are be able to access, retrieve and read the same. More specifically, in operation, encryption fails to prevent interception autonomously, however denies the message content, for instance the generated unique, encrypted and online network ID data or information, to the interceptor, for instance an unauthorized user.

In some embodiments, design, creation and use of retro-coupled, proprietary and custom-designed smart labels (or tags) in the form of stickers capable of being pasted on the physical objects or devices, thereby preventing tampering, peeling or removal and reuse of the sticker-like retro-coupled, proprietary and custom-designed smart labels (or tags) is disclosed, in accordance with the principles of the present invention. Specifically, creation and use of at least one of a tamper-proof, tamper-evident, tamper-resistant patterned, and a combination thereof, multi-layered sticker-like retro-coupled, proprietary and custom-designed smart labels (or tags) is disclosed, in accordance with the principles of the present invention. For example, and in no way limiting the scope of the invention, in some instances, a dual-layered sticker-like retro-coupled, proprietary and custom-designed smart label (or tag) comprises 1) a first layer comprising at least one of a first unique tamper-proof, tamper-evident, tamper-resistant pattern, and a combination thereof, and, or with, a first unique intra-layer pattern alignment therefor, and 2) a second layer comprising at least one of a second unique tamper-proof, tamper-evident, tamper-resistant pattern, and a combination thereof, and, or with, a second unique intra-layer pattern alignment therefor. Specifically, the first layer comprising at least one of the first unique tamper-proof, tamper-evident, tamper-resistant pattern, and the combination thereof, and, or with, the first unique intra-layer pattern alignment therefor, and 2) the second layer comprising at least one of the second unique tamper-proof, tamper-evident, tamper-resistant pattern, and the combination thereof, and, or with, the second unique intra-layer pattern alignment therefor, in combination, or unison, possess a unique inter-layer, i.e. first-is-to-second layer, relative pattern alignment, thereby facilitating misalignment (auto-misalignment) of the unique inter-layer relative pattern alignment by virtue of design of the dual-layered sticker-like retro-coupled, proprietary and custom-designed smart labels (or tags) upon tampering, peeling or removal, in turn, at least one of preventing attempted or forced re-alignment for reuse as well as hampering forced reuse by virtue of material used in, or for, the dual-layered sticker-like retro-coupled, proprietary and custom-designed smart labels (or tags).

At step 408, the method 400 comprises, or facilitates, custom designing a physical object Identification (ID) tag corresponding to each of the one or more passive and active objects, for instance the passive and active objects 102 and 104, of FIG. 1.

At step 410, the method 400 comprises, or facilitates, coupling the generated unique, encrypted and network-based Identification (ID) code with the physical object Identification (ID) tag corresponding to each of the one or more passive and active objects. For example, and in no way limiting the scope of the invention, the generated unique, encrypted and network-based Identification (ID) code 302 is at least one of covertly and imperceptibly embedded, engraved, embossed, printed and written onto to the physical object Identification (ID) tag.

At step 412, the method 400 comprises, or facilitates, retrofitting the physical object Identification (ID) tag to each of the one or more passive and active objects.

At step 414, the method 400 comprises, or facilitates, providing a network for facilitating inter-object interactions and human interactions therewith.

In some scenarios, the unique, encrypted and online or offline network-based Identification (ID) codes are generated and offered to at least one of consumers and product manufacturers for variety of uses. In some scenarios, the unique, encrypted and online or offline network-based Identification (ID) codes are generic, thereby facilitating any user to activate and use the tags.

In some scenarios, for example, and in no way limiting the scope of the invention, any ordinary user can buy the generic unique, encrypted and online or offline network-based Identification (ID) codes and couple the same to the personal belongings, for instance a wallet, using the physical object Identification (ID) tags or labels.

In use, users download, install and run the proprietary client-side object Identity (ID) management application 130 on the at least one of portable and wearable computing and communications device 106 at least one of Free of Charge (FOC) and upon payment of charge from one or more app stores (or app marketplaces).

With reference to FIGS. 1 and 3, in use, the object Identification (ID) code encrypter/decrypter 134, of the object Identity (ID) management application 130 of FIG. 1, encrypts or encodes the unique online network-based Identification (ID) codes 302 generated by the object Identification (ID) code generator 132, of the object Identity (ID) management application 130 of FIG. 1, in a manner such that at least one of A) the characters, for instance at least one of alphabetical, numerical, special characters, and combinations thereof, of the unique online network-based Identification (ID) codes 302 by virtue of the code encryption/encoding algorithm used therefor, and B) the design or pattern of the unique online network-based Identification (ID) codes 302 by virtue of the design or pattern encryption/encoding method or technique used therefor facilitate at least one of concealing and obscuring any information on the proprietary and custom-designed smart label (or tag) 300.

With reference to FIGS. 1 and 3, further, in use, in some scenarios a user utilizes a camera (not shown here explicitly) of the at least one of portable and wearable computing and communications devices 106 to partially manually or automatically capture or scan the unique, encrypted and online network-based Identification (ID) code 302, for instance at least one of a character (or textual) code and design (or pattern or graphical) code. Upon scanning or capturing, the unique, encrypted and online network-based Identification (ID) code 302 is deciphered or decrypted using the object Identification (ID) code encrypter/decrypter 134, of the client-side object Identity (ID) management application 130 downloaded, installed and running on the at least one of portable and wearable computing and communications devices 106 of FIG. 1, based on appropriate decryption algorithms. In some alternate scenarios, a user manually feeds or inputs the unique, encrypted and online network-based Identification (ID) code 302, for instance at least one of the character (or textual) code and design (or pattern or graphical) code, via accessing a customized GUI offered or provided by the front end application, for instance the proprietary client-side object Identity (ID) management application 130, downloaded, installed and running on the at least one of portable and wearable computing and communications devices 106 of FIG. 1, and which GUI is rendered on the first display subunit 122 coupled to the first Input/Output (I/O) subunit 116 thereof. Upon feeding or inputting, the unique, encrypted and online network-based Identification (ID) code 302 is deciphered or decrypted using the object Identification (ID) code encrypter/decrypter 134, of the client-side object Identity (ID) management application 130 downloaded, installed and running on the at least one of portable and wearable computing and communications devices 106 of FIG. 1, based on appropriate decryption algorithms. Upon decryption or deciphering the unique, encrypted and online network-based Identification (ID) code 302 at least one or captured (or scanned) and fed, the decrypted or deciphered code is used index or search or scan the backend database 160, thereby facilitating accessing and retrieving data or information linked to the fed or captured (or scanned) unique, encrypted and online network-based Identification (ID) code 302 imprinted upon or in a given physical object Identification (ID) tag (or label) corresponding to a given physical object or device. For example, and in no way limiting the scope of the invention, the backend database 160 is a secure, online database. In some scenarios, in use, a user can at least one of upload and download multimedia data or information, for instance at least one of audio, text, video, visual (or image or picture), and combinations thereof as well as the unique, encrypted and online network-based Identification (ID) codes 302 imprinted upon or in one or more physical object Identification (ID) tags (or labels) corresponding to one or more physical objects or devices.

With reference to FIGS. 1 and 3, in some embodiments, for example, and in no way limiting the scope of the invention, the front end application, for instance the proprietary client-side object Identity (ID) management application 130, is at least one of a mobile application (mobile app or app) and web-based application (or web app). In use, the object Identification (ID) code scanner or receiver 162 of the proprietary client-side object Identity (ID) management application 130 A) at least one of downloaded, installed and running as an online mobile app on the at least one of portable and wearable computing and communications devices 106, and B) at least one of downloaded, installed and running as a online web app on at least one of fixed and semi-portable computing and communications devices 106 is used to at least one of capture (or scan) using a camera thereof and feed (or input) the unique, encrypted and online network-based Identification (ID) codes 302. Further, in use, the object Identification (ID) code encrypter/decrypter 134 of the front end application, for instance the proprietary client-side object Identity (ID) management application 130, is used to decrypt/decipher the at least one of captured (or scanned) and fed (or inputted) unique, encrypted and online network-based Identification (ID) codes 302. Still further, in use, the front end application, for instance the proprietary client-side object Identity (ID) management application 130, is used to access the backend database 160 using the DBMS 158 and the backend application thereof, for instance the proprietary server-side object Identity (ID) management application 130, in conjunction with the login credentials of users, for instance the User Identification or Identifier (UID) and Password (PWD), and the successfully decrypted/deciphered Identification (ID) codes corresponding to one or more unique, encrypted and online network-based Identification (ID) codes 302. Upon successfully accessing the backend database 160, users can perform one or more desired operations on the backend database 160, such as at least one of uploading desired information or data thereto and downloading as well as retrieving desired information or data therefrom.

At step 416, the method 400 comprises, or facilitates, interacting with the one or more passive and active objects retrofitted with the custom designed physical object Identification (ID) tags using one or more of at least one of portable and wearable computing and communications devices, for instance the at least one of portable and wearable computing and communications devices 106, of FIG. 1.

The method 400 proceeds to step 418 and ends.

### Example Computer System

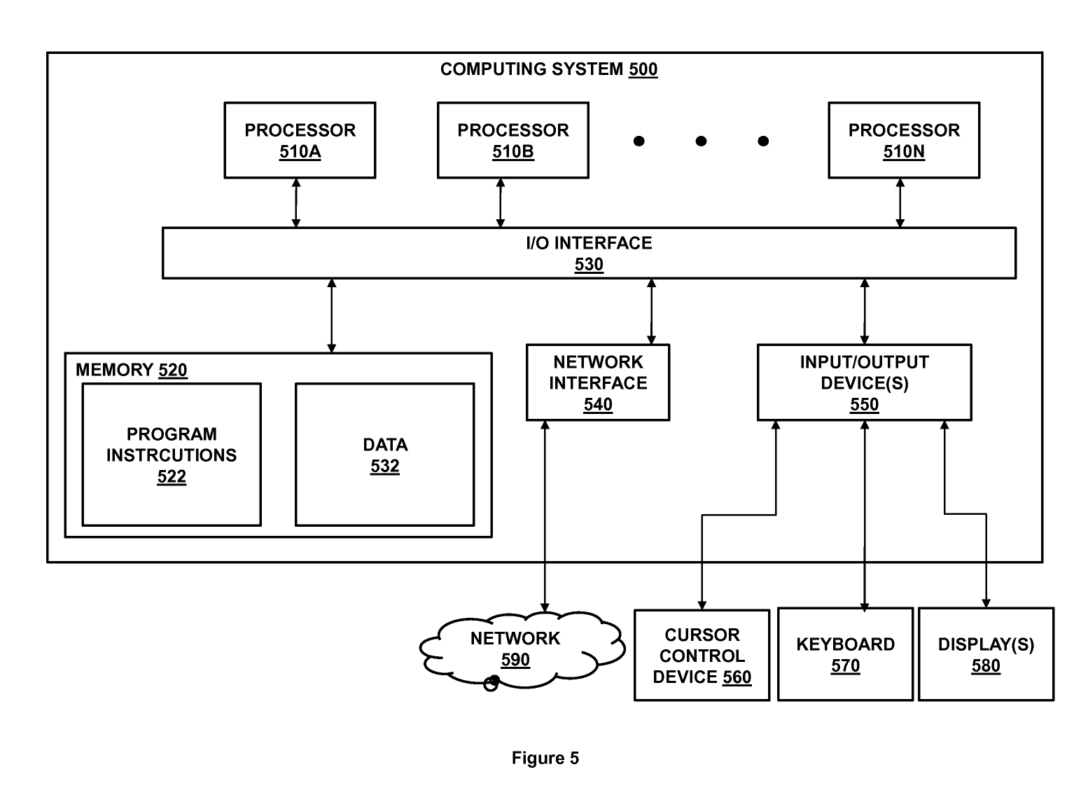

FIG. 5 depicts a computer system that may be a computing device and may be utilized in various embodiments of the present invention.

Various embodiments of the improved system and method facilitating enhanced inter-object and human-object interactivity using networked electronic devices, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement one or more methods described above. The computer system 500 may be used to implement any other system, device, element, functionality or method of the above-described embodiments. In the illustrated embodiments, computer system 500 may be configured to implement one or more methods as processor-executable executable program instructions 522 (e.g., program instructions executable by processor(s) 510A-N) in various embodiments.

In the illustrated embodiment, computer system 500 includes one or more processors 510A-N coupled to a system memory 520 via an input/output (I/O) interface 530. The computer system 500 further includes a network interface 540 coupled to I/O interface 530, and one or more input/output devices 550, such as cursor control device 560, keyboard 570, and display(s) 580. In various embodiments, any of components may be utilized by the system to receive user input described above. In various embodiments, a user interface (e.g., user interface) may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510A-N may be any suitable processor capable of executing instructions. For example, in various embodiments processors 510 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 510A-N may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one components (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for facilitating enhanced inter-object and human-object interactivity using networked electronic devices, the method comprising:
providing one or more passive and active objects;
generating and assigning a unique, encrypted and network-based Identification (ID) code corresponding to each of the one or more passive and active objects;
custom designing a physical object Identification (ID) tag corresponding to each of the one or more passive and active objects;
coupling the generated unique, encrypted and network-based Identification (ID) code with the physical object Identification (ID) tag corresponding to each of the one or more passive and active objects;
retrofitting the physical object Identification (ID) tag to each of the one or more passive and active objects;
providing a network for facilitating inter-object interactions and human interactions therewith; and
interacting with the one or more passive and active objects retrofitted with the custom designed physical object Identification (ID) tags using one or more of at least one of portable and wearable computing and communications devices via the network, thereby facilitating realization of web of everything and anything.

2. The method of claim 1, wherein the one or more passive objects are at least one of offline electronic and non-electronic devices, appliances and apparatuses.

3. The method of claim 1, wherein the one or more active objects are online electronic devices, appliances and apparatuses.

4. The method of claim 1, wherein the unique, encrypted and network-based Identification (ID) code is at least one of an offline and online network-based, and wherein the offline network is a wireless non-Internet network, whereas the online network is an Internet network.

5. The method of claim 4, wherein the unique, encrypted and network-based Identification (ID) code is encoded in such a way that only authorized users are be able to access, retrieve, decrypt, read and use the same.

6. The method of claim 1, wherein the custom designed physical object Identification (ID) tag corresponding to each of the one or more passive and active objects is at least one of a tamper-proof, tamper-evident, tamper-resistant patterned, and a combination thereof, multi-layered sticker-like smart label.

7. The method of claim 6, wherein the custom designed physical object Identification (ID) tag corresponding to each of the one or more passive and active objects is at least one of a tamper-proof, tamper-evident, tamper-resistant patterned, and a combination thereof, double-layered sticker-like smart label.

8. The method of claim 7, wherein the at least one of the tamper-proof, tamper-evident, tamper-resistant patterned, and a combination thereof, double-layered sticker-like smart label comprises A) a first layer comprising at least one of a first unique tamper-proof, tamper-evident, tamper-resistant pattern, and a combination thereof, with a first unique intra-layer pattern alignment therefor, and B) a second layer comprising at least one of a second unique tamper-proof, tamper-evident, tamper-resistant pattern, and a combination thereof, with a second unique intra-layer pattern alignment therefor.

9. The method of claim 8, wherein the first layer comprising the at least one of the first unique tamper-proof, tamper-evident, tamper-resistant pattern, and the combination thereof, with the first unique intra-layer pattern alignment therefor, and the second layer comprising at least one of the second unique tamper-proof, tamper-evident, tamper-resistant pattern, and the combination thereof, with the second unique intra-layer pattern alignment therefor, in combination, or unison, possess a unique inter-layer relative pattern alignment.

10. The method of claim 9, wherein the at least one of the tamper-proof, tamper-evident, tamper-resistant patterned, and a combination thereof, double-layered sticker-like smart label facilitates auto-misalignment of the unique inter-layer relative pattern alignment by virtue of design of the dual-layered sticker-like smart label upon at least one of tampering, peeling and removal, in turn, at least one of preventing at least one of attempted and forced re-alignment for reuse as well as hampering forced reuse by virtue of material used for the design of the dual-layered sticker-like smart label.

11. The method of claim 1, wherein the step of retrofitting the physical object Identification (ID) tag to each of the one or more passive and active objects facilitates enabling each of the one or more passive and active objects for inter-object interactions and human interactions therewith.

12. The method of claim 1, wherein the step of interacting with the one or more passive and active objects retrofitted with the custom designed physical object Identification (ID) tags using one or more of at least one of portable and wearable computing and communications devices via the network further comprises:
at least one of downloading, installing and implementing a proprietary object Identity (ID) management application using the at least one of portable and wearable computing and communications device;
inputting the login credentials of a registered user comprising a User Identifier (UID) and a corresponding Password (PWD) for Authentication, Authorization and Accounting (AAA) of the registered user by at least one of an offline networked and online cloud-based secure host computing unit, thereby facilitating initiation of the proprietary object Identity (ID) management application;
upon successful AAA of the registered user, at least one of scanning and optionally inputting the unique, encrypted and network-based Identification (ID) code generated and assigned to each of the one or more passive and active objects using an object Identification (ID) code scanner of the object Identity (ID) management application;
decrypting the unique, encrypted and network-based Identification (ID) code generated and assigned to each of the one or more passive and active objects using an object Identification (ID) code encrypter/decrypter of the object Identity (ID) management application;
accessing the at least one of an offline networked and online cloud-based secure host computing unit using the decrypted Identification (ID) code corresponding to each of the one or more passive and active objects to retrieve the information in connection therewith;
determining the access type and activation state of the Identification (ID) code corresponding to each of the one or more passive and active objects, wherein the access type is at least one of open and limited, whereas the activation state is at least one of activated and deactivated;
activating the Identification (ID) code corresponding to each of the one or more passive and active objects to define one or more access permissions to the Identification (ID) code for at least one of individual and group users and the time period of expiry of the Identification (ID) code as an owner user;
analyzing the information in connection with the each of the one or more passive and active objects;
profiling each of the one or more passive and active objects partly based on at last one of the results of the analysis, the historical use, context of use, corresponding users, attributes, functions and performance thereof;
categorizing each of the one or more passive and active objects based on the profile;
recommending one or more uses of the each of the one or more passive and active objects, and at least one of applicability and reliability thereof, based on at least one of the historical use, context of use, pricing trends, demand patterns, corresponding users, attributes thereof, functions and performance; and
tracking efficacy of the each of the one or more passive and active objects based on at least one of performance, sales, efficiency, peer reviews, and the like.

13. The method of claim 12, wherein the step of decrypting the unique, encrypted and network-based Identification (ID) code generated and assigned to each of the one or more passive and active objects using the object Identification (ID) code encrypter/decrypter of the object Identity (ID) management application downloaded, installed and running on the at least one of portable and wearable computing and communications device.

14. The method of claim 12, wherein upon activating the Identification (ID) code corresponding to each of the one or more passive and active objects, the owner user is capable of uploading one or more data or information to a database of the at least one offline networked and online secure host computing unit linked with the Identification (ID) code using the proprietary object Identity (ID) management application.

15. The method of claim 14, wherein upon activating the Identification (ID) code corresponding to each of the one or more passive and active objects, any non-owner user is capable of scanning the Identification (ID) code using the proprietary object Identity (ID) management application downloaded, installed and running on the at least one of portable and wearable computing and communications device, owned and operated by the non-owner user, to at least one of view and upload data or information to the Identification (ID) code, subject to the access permissions thereof defined by the owner user.

16. The method of claim 15, wherein at least one of the one or more passive and active objects is a personal belonging is at least one of a wallet, purse and an Identity (ID) card.

17. The method of claim 16, wherein the owner user is capable of monitoring one or more non-owner users who scanned the Identification (ID) tag of the personal belonging comprising the Identification (ID) code, upon loss of the personal belonging.

18. The method of claim 17, wherein the Identification (ID) code corresponding to the personal belonging is capable of being deactivated and the access permissions thereto changed at any period in time by the owner user.

19. The method of claim 1, wherein one or more users are capable of autonomously assigning one or more unique, encrypted and network-based Identification (ID) codes, and wherein the each of the one or more users are capable of publishing a unique, encrypted and network-based Identification (ID) code based on time, location and context.

20. The method of claim 1, wherein the one or more unique, encrypted and network-based Identification (ID) codes are capable of changing automatically based on at least one of predefined algorithms.
